(19) United States
(12) Patent Application Publication
(10) Pub. No.: US 2019/0114593 A1
(43) Pub. Date: Apr. 18, 2019

(54) METHOD AND SYSTEM FOR MANAGING, MATCHING, AND SOURCING EMPLOYMENT CANDIDATES IN A RECRUITMENT CAMPAIGN

(71) Applicant: ExpertHiring, LLC, Piscataway, NJ (US)

(72) Inventor: Paul CHAMPANERIA, Branchburg, NJ (US)

(73) Assignee: ExpertHiring, LLC, Piscataway, NJ (US)

(21) Appl. No.: 16/162,680

(22) Filed: Oct. 17, 2018

Related U.S. Application Data
(60) Provisional application No. 62/573,375, filed on Oct. 17, 2017.

(51) Int. Cl. G06Q 10/10; G06F 17/30

(52) U.S. Cl. CPC G06Q 10/1053; G06F 17/3053; G06F 17/30654

(57) ABSTRACT

A method and system for automating some aspects of a recruiting process, which may implement rules permitting the processes of sourcing candidates, setting up job interviews, and responding to candidate questions to all be automated with a computer. Such a system may match résumés and job descriptions with a scoring system, and may initiate communications between one or more candidates and a recruiter once an appropriate number of matches have been found. The system may then be configured to field responses to commonly asked questions from a question database, and notify the recruiter if a question is asked that it cannot answer, and may further be configured to proactively ask questions to the candidate if desired. This may allow recruiters to focus on the highest level of vetting, and on aspects of the recruitment process such as promoting the hiring company and salary negotiations.

### CLAIM OF PRIORITY

This application claims priority from U.S. Provisional Patent Application No. 65/573,375, filed on Oct. 17, 2017, entitled “METHOD AND SYSTEM FOR MANAGING, MATCHING, AND SOURCING EMPLOYMENT CANDIDATES IN A RECRUITMENT CAMPAIGN,” the entire contents of which are hereby incorporated by reference.

### BACKGROUND

Hiring and recruitment of candidates for a position of employment is generally a long, complex process. Generally, the process operates as follows. First, an HR department of a company or organization will identify that there is a vacancy in a particular position or identify that there is a need to create a new position. HR must then identify what the duties and responsibilities of the position will be, and must establish minimum requirements, preferred qualifications, and a recruitment strategy for the position.

Then, HR must develop a position description to be provided to the public. This typically must balance factors like accurately describing the duties and responsibilities of the job while preserving appropriate levels of secrecy about how the organization operates, ensuring that the position description ranks high in the search results of a number of search engines, ensuring that the position description promotes the company, and ensuring that the posting complies with labor law.

While some recruitment is often done in-house (usually through a jobs board operated by the organization, or through an in-house recruiter if the organization is sufficiently large and has sufficient turnover), the task of recruiting candidates for the position is sufficiently onerous and specialized that, most often, recruitment is contracted out to a recruiter or staffing agency. The recruiter will, based on the position description developed by the company, attempt to source a number of appropriate candidates for the position and ensure that the candidates are appropriately qualified.

The process of “sourcing” a candidate refers to the process of proactively searching for qualified job candidates for positions which are currently open or which are planned to be open. Sourcing thus requires collecting relevant data about qualified candidates, such as their names, titles, and job responsibilities. This is targeted at both candidates who are not actively looking for job opportunities (passive job seekers) and candidates who are actively looking for job opportunities (active job seekers). Both passive and active job seekers are most often targeted based on digital job boards, social media, and based on various forms of networking, such as through professional or alumni organizations.

Countless hours are typically spent by recruiters on both sourcing and qualifying candidates for job openings, meaning that this process can often be expensive, particularly for a company that contracts out its recruitment. The widespread adoption of digital job boards has meant that the volume of résumés and applications has increased significantly, making this task progressively more difficult.

Despite this extensive effort, and despite the extensive experience of recruiters and hiring managers, the vast majority of this effort is wasted, and the vast majority of candidates never hear back after submitting their information to a recruiter. A majority of candidates submitted by a recruiter to a hiring manager (often around 50% to 70% of such candidates) tend to be rejected by the hiring managers, on the grounds that the hiring manager did not feel that the candidate was likely to be a match after having a chance to review the candidate's resume. There are a multitude of reasons for this; for example, this could be the result of a job description that is not clearly written, could be the result of a misunderstanding between the recruiter and hiring manager, or could be the result of a lack of understanding that the recruiter has of the job, which may particularly be the case for technical jobs. This extensive waste of effort on the part of recruiters, candidates, and even hiring managers results in a significant degree of frustration all around, and results in significant delays in the hiring process.

For example, one of the main reasons why it can be so difficult to find acceptable candidates to fill a position is that the job descriptions provided for such positions are often highly flawed. Bad job descriptions are the root cause of a large number of problems that can be encountered during the hiring process. In many cases, job descriptions are drafted based on outdated information, or are drafted by someone who is not “in the loop” about the actual requirements of the job and does not understand the relative importance of particular skills or responsibilities. For example, a job description may not accurately convey the responsibilities of the job or the skills needed to perform it because the company is making use of a job description template which is outdated, which has been ineffective, or which is a mere copy of a form template found online and which is in no way tailored to the particular position in question.

Further, a job description may not always be static. The requirements of a job as initially laid out early in the hiring process may change as the hiring process develops, whether because of developments that take place in the hiring process or developments that take place outside it. For example, hiring managers may wish to change what they want in a candidate (something frequently done) when they have had a chance to review the resumes of candidates for the position or have had a chance to interview candidates. (For example, they may find that candidates for the position are overqualified and asking for a salary far in excess of what they anticipated paying, or they may find that candidates for the position are underqualified. They may also find that candidates for the position are lacking in certain skills, or have misinterpreted aspects of the job description.) The needs of the company that led to a particular position being made available may also change; for example, candidates for a position at a tech startup may be intended to assist with a particular project, and the requirements of that project may change. A candidate may have to have familiarity with an additional language or framework in order to assist with development of a new feature, restricting the candidates that can be considered for the position; alternatively, certain skills or responsibilities may become unnecessary (for example, because it has determined they will not be necessary, because a feature has been developed already, because it has been determined that the feature will not be developed, or because another candidate has been hired for another position who has those skills or can fulfill those responsibilities instead).

Candidates, likewise, may be harmed by these inadequacies in job descriptions. If a job description is inaccurate, misleading, or otherwise inadequate, a candidate may apply to a position that they may not actually be interested in, and may lose interest in their application once the details of the job description are clarified. Further, if there is a significant mismatch between the listed requirements of the job description and the requirements for the candidate to receive an interview, or the requirements for a candidate to be contacted, the candidate may become frustrated during the application process. The candidate may spend a significant amount of time talking to recruiters, filling out applications, and otherwise applying for positions; after sending out all of these applications, in the vast majority of cases, the candidate may not even receive a courtesy communication from the recruiter indicating that they have been passed over. The candidate may receive an interview in fewer cases than that.

The difficulties involved with properly generating a job description and matching candidates to it complicate the hiring process and contribute to hiring taking much longer than it should. In the vast majority of organizations, the time between posting a job description and hiring a candidate is over 57 days. In some cases, where there is a scarcity of candidates who fit a job description, or when there is some uncertainty as to what skills or certifications may actually be needed to perform a job, the time to hire may be even longer. For example, some tech roles have been known to take upwards of 100 days to fill.

The extensive amount of time required to fully vet candidates for a position may further result in recruiters/hiring managers and candidates creating increased difficulties for each other. For example, because it can take so long to secure a candidate for a position, recruiters regularly attempt to maintain other alternative candidates for the position. A recruiter that is engaging in talks with a first-choice hire for a position may attempt to keep second- and third-choice candidates in play as potential backups in case the talks with the first-choice candidate break down, and one of the primary ways in which these candidates may be kept in play is simply to not contact them until matters are settled with the first-choice candidate. For this reason, even candidates who are well-suited to a position often do not hear back from a recruiter. This means that it may become increasingly difficult to get candidates to respond, if 90% of the time the candidate does not hear anything meaningful back from a recruiter (or is given only token feedback in an attempt to “keep them warm”), because the candidate will feel like they are just wasting time talking to recruiters and applying for jobs.

This can also lead to difficulties if the recruiter or candidate need to clarify any information involved in the hiring process. For example, a hiring manager or recruiter may have certain questions about a candidate after reviewing the candidate's resume or profile, in the hopes of upgrading a candidate from a second-choice candidate to a potential interviewee. However, if it has been too long since the candidate has been contacted, the candidate may not feel like they have been prioritized and may take an extensive amount of time to answer, or may draw the hiring manager into an extended conversation that they do not have the time to engage in. As such, if the hiring manager does not want to provide an opening for the candidate to turn the hiring manager's simple question into a 30-minute conversation, or does not have the time to conduct it, the hiring manager may not call or email the candidate with their questions, leading to an inefficient hiring decision being made.

One final structural problem is that the extensive amount of time that must be spent on a particular candidate may obligate a recruiter to spend an increased amount of time on that candidate, adding undesirable positive feedback to the hiring process. Because it takes so much time and effort (and thus cost) from the recruiter or hiring manager to bring a candidate through the hiring process, a recruiter or hiring manager is incentivized to put in significant time and effort to vet the candidate in order to ensure that those costs are not wasted on a dubious candidate. This means that the recruiter spends even more time on the candidate and has even less time available to conduct a broad hiring process, creating further inefficiencies.

### SUMMARY

A method and system for automating some aspects of a recruiting process may be described. Such a method may operate to match résumés and job descriptions, and may initiate communications between a candidate and a recruiter once an appropriate match has been found. This may allow recruiters to focus on the highest level of vetting, and on aspects of the recruitment process such as promoting of the hiring company and salary negotiations.

According to an exemplary embodiment, a method, which may be performed by a system configured to implement the method, may start with receiving, on an automated recruitment system, a job description or plurality thereof. The method may next include parsing, with the automated recruitment system, the job description, the step of parsing the job description including identifying one or more job requirements of the job description (such as, for example, the job title, the skills and experience required and preferred, the education requirements, the day-to-day duties and expectations of the position, and so forth). In some exemplary embodiments, the job description may include, or may be paired along with, identifiers of one or more job requirements of the job description (which may, for example, ensure that the job description is more easily parsed). For example, according to an exemplary embodiment, a hiring manager may specifically provide the top three to top five skills or types/level of experience that is needed for the job, along with the job description; in some exemplary embodiments, skills, experience, or other such qualities that have been indicated by a hiring manager as being important may be given additional weight in a matching and scoring process, if desired. The method may next include generating, on the automated recruitment system, a first data point matrix, the data point matrix based on the one or more job requirements. The method may next include automatically posting, with the automated recruitment system, on a network, one or more posts comprising the job description. The method may next include automatically maintaining, with the automated recruitment system, the one or more posts, which may be continued over a period of time.

Next, the method may include, for a plurality of candidates, performing a step of receiving, on the automated system, a sourced résumé of a candidate in the plurality of candidates (which may be, for example, a formal résumé, or may be another source of candidate information such as a candidate social media profile), and parsing the sourced résumé, which may include identifying hiring information for the candidate; this hiring information may include any or all information relevant to the hiring of the candidate, such as the candidate's location, the candidate's desired salary, information related to past interactions with the candidate, and so forth. (In some exemplary embodiments, a “résumé” may be multiple items or sources of information, and the desired candidate information may be assembled from each of these items or sources of information. For example, in an exemplary embodiment, certain information such as name, contact information, candidate summary information, work history of a candidate with their present employer, the candidate's current job title, the candidate's start and end dates of employment, and the candidate's education information may be parsed from a formal résumé, and additional information from a jobs board or other source location may be combined with this formal résumé candidate information.) The method may next include generating, on the automated recruitment system, a second data point matrix, the data point matrix being based on the hiring information for the candidate; generating, with a semantic engine of the automated recruitment system (or an analogous system or other means), a candidate score for the candidate by matching the hiring information in the second data point matrix to the one or more job requirements in the first data point matrix; and automatically sending, with the automated recruitment system, a contact message to the candidate. This contact message may be, for example, a list of top reasons to work for the employer, a more extensive job description, a link to apply for a position, or any other contact message that may be desired. Finally, the method may include receiving, on the automated recruitment system, a response of the candidate; and evaluating, on the automated recruitment system, the response of the candidate to determine if the response of the candidate is an intent to apply, a rejection, or a question.

When the response of the candidate is an intent to apply, in some exemplary embodiments, the candidate may communicate such an intent to apply by clicking a link to apply. In some exemplary embodiments, this may provide the candidate with an opportunity to review and update the information on file for the candidate, as well as provide additional information or additional documents where appropriate (for example, in some exemplary embodiments, the candidate may provide an updated résumé or may provide additional information by filling out skills questions). The method may include adding the candidate to a curated list of candidates, and submitting the curated list of candidates to a hiring manager, recruiter, or similar party. When the response of the candidate is a rejection, the method may include ensuring that the candidate is not part of an active campaign, by, for example, removing the candidate from the campaign. (In some exemplary embodiments, the candidate may be asked why they are not interested before they are removed from the campaign, which may provide the candidate an opportunity to clarify or even retract their rejection; for example, in some exemplary embodiments, the candidate may be asked whether they are open to a new job right now, or whether they are simply interested in the position that was offered to them.) When the response of the candidate is a question, the method may perform at least one of automatically generating a response to the question (for example, through the use of an AI, or by determining if the question matches an entry in an auto-response database of the automated recruitment system and generating a response from the entry in the auto-response database) or sending a notification to an operator of the automated recruitment system indicating that the question cannot be automatically responded to. (In some exemplary embodiments, an auto-response database may access the candidate information and/or the job description information in addition to the auto-response database in order to generate a response specifically tailored to a particular job or a particular candidate.) Finally, once the campaign includes at least one candidate, the method may include submitting, with the automated recruitment system, the curated list of candidates, to an appropriate party (such as a hiring manager or recruiter); in an exemplary embodiment, this may be done immediately after a candidate has completed the application process or may be done in a batch of multiple candidates, as may be desired. In an exemplary embodiment, submission of the curated list of candidates may include submission of detailed information about the candidates in the campaign, such as the résumé of each candidate, details about the skills required for the job such as the number of required or suggested years of experience or the last year the skill was used, salary details, availability information for the candidate such as a date on which the candidate is available to start, and so forth.

In an exemplary embodiment, the method may further include performing the step of identifying, with a web-based or otherwise machine-based calendar system such as MICROSOFT OUTLOOK, a mutually acceptable time for scheduling an interview, and automatically scheduling an interview at the mutually acceptable time.

In an exemplary embodiment, the method may further include generating, from the one or more job requirements, one or more search strings for a job board search engine or other search engine; in some exemplary embodiments, a plurality of successive search strings may be provided, each of which has broader search parameters than the last search string in at least one way. In some exemplary embodiments, the combination or combinations of values, and the number of parameters, to be included in a search string may be determined manually, or may be determined automatically by the system based on settings such as the weight of importance assigned to one parameter or parameter value over another. In some exemplary embodiments, the generation of search strings may be performed before performing the other steps of the method or at an early stage of performing the steps of the method. This may enable manual sourcing to be performed more easily, alongside automatic sourcing. As such, the method may be able to incorporate candidate résumés from a plurality of sources, which may include, for example, résumés sourced from automated and manual job board searching, résumés submitted by candidates directly or through a job board, or résumés or other information retrieved from social media sites.

In an exemplary embodiment, the step of automatically posting one or more posts with the job description may further include the steps of automatically generating, from the job description, a base post; automatically formatting the base post into one or more site-specific posts, each of the site-specific posts having a format used by a specific website; and posting the site-specific posts on the specific websites. This may ensure that the information in each post is largely shared, but that differences (such as formatting differences) between multiple sites are taken into account.

In an exemplary embodiment, the method may further include identifying a website that does not permit at least one of automatic posting or automatic maintenance of posting; automatically generating a post to be made on the website, or an edit to be applied to a post on the website; and generating and sending a notification to an operator of the automated recruitment system. The notification may further include the post to be made on the website or the edit to be applied to the post on the website, to allow the operator (such as a recruiter) to make the post or make the edit quickly, after a brief review.

In an exemplary embodiment, the step of automatically maintaining, with the automated recruitment system, the one or more posts may constitute or may include at least one of updating the one or more posts to include new job description information, removing the one or more posts, or applying a visibility adjustment to the one or more posts.

In an exemplary embodiment, the plurality of candidates may include at least a primary group, the primary group being formed from candidates having a candidate score in excess of a primary score threshold. This plurality of candidates may further include a secondary group, the secondary group being formed from candidates having a candidate score in excess of a secondary score threshold but below the primary score threshold. In an embodiment, the method step of automatically sending, with the automated recruitment system, a contact message to the candidate, this message including an offer to apply for a position may be performed for each of the candidates in the primary group before being performed for any of the candidates in the secondary group.

In an exemplary embodiment, when the response of the candidate is a rejection, the candidate may be excluded from receiving at least one category of offer for at least one period of time. This may constitute excluding the candidate from at least one of offers in a particular industry segment, offers having a specific job title, offers having a specific job description, offers having a specific salary, offers having a specific job location, or other offers, as may be desired.

In an exemplary embodiment, when the response of the candidate is a question and not an intent to apply or a rejection, the method may include sending a further communication to the candidate requesting a second response.

A further exemplary embodiment of a method and system such as described herein may feature refinements to the step of creating a job description. In some exemplary embodiments, this method and system may be facilitated by the use of an AI BOT.

According to an exemplary embodiment, an AI BOT may be configured to facilitate the development of a new job description for a new position. In some exemplary embodiments, an AI BOT may be configured to develop a job description based on a series of questions asked to a hiring manager, using one or more communications methods, and/or may be configured to provide guidance to a hiring manager to assist the hiring manager in formulating an accurate and clear job description. For example, according to an exemplary embodiment, an AI BOT may be configured to ask a hiring manager what an appropriate job title for a position would be. In another exemplary embodiment, an AI BOT may receive a job title from a hiring manager, and may offer guidance as to the choice of a better job title for the position; for example, an AI BOT may suggest a more accurate job title for the position, or a job title more similar to the job titles used by other companies offering similar positions.

According to an exemplary embodiment, an AI BOT may be configured to adapt an existing job description to be more reflective of the actual skills and responsibilities of a position. As before, according to some exemplary embodiments, the AI BOT may be configured to ask questions and/or offer guidance in order to develop a new job description.

An exemplary embodiment of the system may specifically provide a computer-implemented method for automated “dialectic” generation of a job description, or dialogue/question-and-answer based generation of the job description. This may include the steps of providing an automated job description system including a natural language processing engine, a processor, a memory, and a network connection; generating at least one question to be provided to a user, providing the at least one question to the user, receiving at least one answer from the user, and parsing the at least one answer into one or more specified job requirements; data mining, via the network connection, employment data for one or more extrinsic job requirements; generating a preliminary job description based on the one or more specified job requirements and the one or more extrinsic job requirements; and providing the preliminary job description to the user. This user may be a hiring manager, an outside contractor such as a recruiter, or any other user such as may be desired. (For example, it may well be contemplated to have such a system provided to a sole proprietor of a business or other inexperienced or unsophisticated user, just the same as it may be provided to a hiring manager.)

The method may further include the steps of identifying a job subject area and automatically loading, with the processor, a job description template for the job subject area, the step of automatically loading the job description template comprising at least one of the set of: retrieving the job description template from a memory (for example, a locally-generated template), and automatically retrieving the job description template via the network connection (for example, an externally-retrieved template, or a template based on data mining of other positions). The step of generating a preliminary job description may include modifying the job description template based on the one or more specified job requirements and the one or more extrinsic job requirements.

The method may further include the steps of identifying an existing job description for a position, wherein the existing job description can be, for example, an unposted job description, or a previously-posted job description provided in the memory or via the network connection. The processor may automatically load the existing job description. The step of generating a preliminary job description may include modifying the job description template based on the one or more specified job requirements and the one or more extrinsic job requirements.

The method may further include generating a plurality of questions to be provided to the user through an iterative process, wherein a first answer of the user to a first question in the plurality of questions is used to generate a second question in the plurality of questions. Likewise, the system may circle back to a first question if a second answer seems to contradict a first answer, if desired.

A data mining step may include identifying, based on the at least one answer of the user, a plurality of related job descriptions in at least one job database (such as an external job board), and identifying, from the plurality of related job descriptions, the one or more extrinsic job requirements.

The method may further include receiving a revised job description from the user, and automatically posting the revised job description in at least one job database. (In some variants, the preliminary job description may be automatically posted without further input.)

The method may further include, based on the revised job description received from the user, performing at least one of: generating at least one further question to be provided to a user, providing the at least one further question to the user, receiving at least one further answer from the user, and parsing the at least one answer into one or more revised job requirements; and data mining, via the network connection, employment data for one or more revised job requirements, and generating at least one comparison based on the mined employment data. (For example, the revised job description may present new issues, such as a title to be provided with the position; a user may be better able to select an appropriate title for the position based on what is used elsewhere.)

The method may further include selecting a first communications method for providing the at least one question to the user; receiving the at least one answer from the user via a second communications method; and updating a communications preference to be the second communications method. (For example, if a first message is sent by an instant messaging tool and the reply message is by email, the system may switch to email.)

The method may further include a configuration wherein the data mining step is specifically a salary mining step, and wherein the salary mining step includes identifying one or more comparable openings, wherein a comparable opening is an opening with a plurality of similar attributes selected from the set of: a location, a title, a responsibility of a worker in a hiring company, and a posted responsibility of a job description posted in a job database; and determining a salary or salary range from each of the one or more comparable openings.

The method may further include sourcing a plurality of candidates based on the one or more specified job requirements and the one or more extrinsic job requirements of the preliminary job description. In some variants, the plurality of candidates may be sourced in substantial real time and displayed to the user as they are sourced. In such variants, and others, the user may provide at least one job description adjustment request with an adjusted job description, which may cause the system to adjust the sourcing to use the adjusted job description and generate a new plurality of candidates in substantial real time and display the new plurality of candidates as they are sourced.

The method may further include receiving at least one of an approval message or a disapproval message for at least one of the plurality of candidates. If a disapproval message is received, based on the disapproval message, the system may generate at least one question to be provided to the user regarding the suitability of the candidate. Based on the user's answer, the job description may be updated. If an approval message is received, the system may try to automatically arrange an interview, which may include identifying, from a calendar of a user, a potential interview time, and identifying, from a set of preferences of a user, a potential interview method; and automatically preparing and sending an interview request for the potential interview time and the potential interview method. If the candidate declines the interview, a recommendation may be generated for the user (which may be based on the candidate's language or based on other trends in the hiring market), and a communication may be generated for the candidate with at least one proposed revision to the job description.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a flowchart depicting a method of automating a recruiting process.

FIG. 2 is an exemplary embodiment of a flowchart depicting a method of performing a job entry step.

FIG. 3 is an exemplary embodiment of a flowchart depicting a method of performing a sourcing step.

FIG. 4 is an exemplary embodiment of a flowchart depicting a method of performing a matching step.

FIG. 5 is an exemplary embodiment of a flowchart depicting a method of performing a contact step.

FIG. 6 is an exemplary embodiment of a flowchart depicting a method of performing a response step.

FIG. 7 is an exemplary embodiment of a flowchart depicting a method of performing a review step.

FIG. 8 is an exemplary embodiment of a flowchart depicting a method of performing an offer and acceptance step.

FIG. 9 is an exemplary embodiment of a flowchart depicting a method of creating a job description, which may be performed alongside or instead of a method for automating a recruiting process such as may be depicted in FIG. 1.

FIG. 10 is an exemplary embodiment of a flowchart depicting a more detailed breakdown of a job description preliminary input step such as may be shown in FIG. 9.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. Further, as used in the specification, the term “résumé” may be used to refer to all information that may be solicited from or provided by a candidate for an employment position, including a résumé document, but also including, for example, social media information of the candidate, information provided by the candidate in response to questionnaires, data collected from a personal web page of the candidate or an employment web page of the candidate, or any other information that may be relevant to the hiring of the candidate.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a method and system for automating a recruiting process may be disclosed. Such a method and system may function to better match candidates with job openings, and may implement rules permitting the processes of vetting candidates and setting up job interviews to be automated with a computer. In particular, the method and system may make use of a method for providing a candidate with a score for a particular job opening. The method and system may then collect any other information that may be necessary, and may be configured to notify employers about one or more high-scoring candidates that have been found for a job opening. The method and system may further operate to maintain bi-directional communication until such time as the position has been filled.

Such a system for automating the process of selecting and vetting candidates for a position may have numerous advantages. In particular, the system may substantially increase recruiter productivity by automating the communication process between the recruiter, candidate, and hiring manager, and by providing automatic responses to common questions. The system may also significantly reduce the time and expense required to train a recruiter in a particular field, and may even allow other employees to take on the specialized task of recruitment, allowing employees in specialized departments (such as engineering or IT) to more closely vet recruited candidates with their own specialized knowledge.

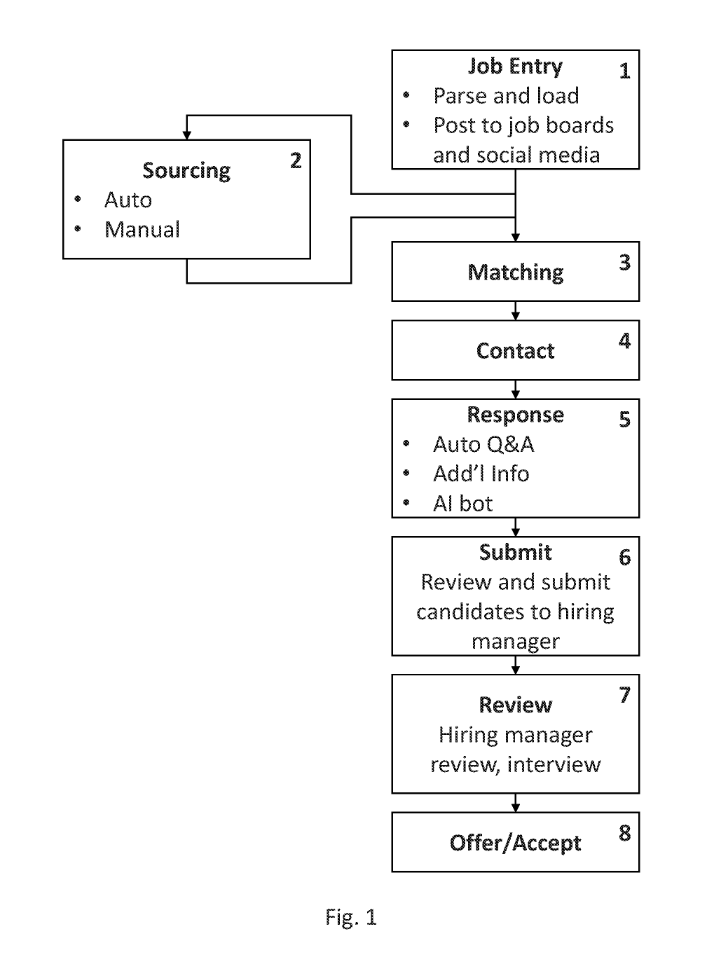

Turning now to exemplary FIG. 1, FIG. 1 displays an exemplary embodiment of a flowchart depicting a method of automating a recruiting process. Such a method may include several steps, including a job entry step 1, a sourcing step 2, a matching step 3, a contact step 4, a response step 5, a submission step 6, a review step 7, and an offer and acceptance step 8. In an exemplary embodiment, these steps may be run sequentially, in parallel, or in some combination of the two; for example, according to an exemplary embodiment, a matching process 3 and a sourcing process 2 may be run simultaneously, such that the matching process 3 performs matching on résumés already in the system, while the sourcing process 2 performs sourcing on newly-added or newly-updated résumés.

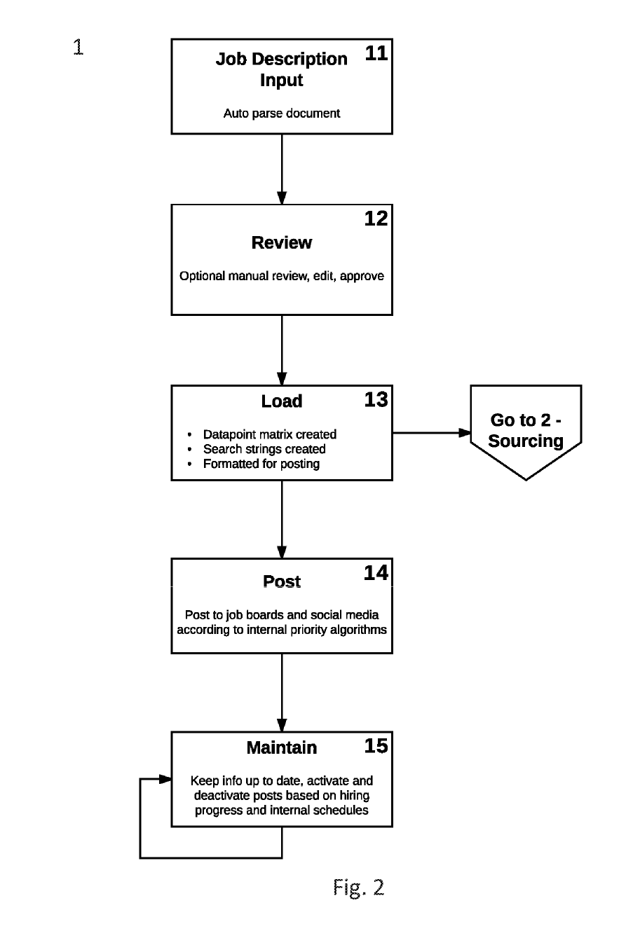

Turning briefly to exemplary FIG. 2, FIG. 2 displays, in more detail, an exemplary embodiment of a flowchart depicting a method of performing a job entry step 1. According to an exemplary embodiment, in a first step 11 of a job entry step 1, a job description may be input into the system. In some embodiments, the text of the job description, and any other information that has been provided by the hiring manager that may be outside of the job description, may be parsed by the system (for example, by a system configured to use natural language processing) and key points, concepts, and requirements of the job may be identified from the job description.

In a next step 12 of a job entry step 1, the information that had been automatically parsed from the job description in step 11 may be reviewed by a human operator, such as a recruiter. The recruiter may then elect to edit the information that had been produced in the automatic parsing step 11. In some exemplary embodiments, the recruiter may have to review and approve the information in order to continue with the job entry step 1; in other exemplary embodiments, the recruiter may have the option to do so.

In a next step 13 of a job entry step 1, the job description may be loaded into the system based on the parsing of step 11 (and optionally the manual review of step 12). A data point matrix may then be created in the system for subsequent matching of the information in the job description to information of one or more potential candidates for the position.

According to an exemplary embodiment, a data point matrix may be a data structure that may be represented by a multi-dimensional environment (that is, an environment having one or more axes) wherein each relevant piece of information in the data structure, i.e. each data point, can be represented by a point in the environment having a specific set of coordinates that define its position based on the relevancy of the information in the data point to the concepts or requirements that are represented by the axes or coordinate planes.

Various other representations of data may be constructed using the general framework of a data point matrix. For example, a data vector may be constructed within the data point matrix, which may be represented by a conceptual line that can be drawn through the locales of the greatest concentrations of data points in a data point matrix.

In some exemplary embodiments, a data point matrix (DPM), and/or a data vector (DV), which have been derived from a first entity may be compared to a DPM and/or DV that have been derived from a second entity, by using the first DPM or DV as a template to overlay onto the second DPM or DV. This may allow the relevancy of the first entity to the second entity to be evaluated. For example, according to an exemplary embodiment, a first DPM or DV may be a job description, and a second DPM or DV may be a résumé (or vice-versa). The job description and the résumé may thus be compared by overlaying the first DPM or DV over the second DPM or DV and examining the similarities.

In some exemplary embodiments, a system may make use of one or more alternative methods of matching information in the job description to information of one or more potential candidates for the position, in addition to the use of a data point matrix or instead of the use of a data point matrix. For example, according to some exemplary embodiments, a system may make use of, as a method of matching information in the job description to information of one or more potential candidates for the position: machine learning; one or more neural networks; multi-layer perceptrons; support vector machines; principal components analysis; Bayesian classifiers; Fisher discriminant analysis; linear discriminant analysis; maximum likelihood estimation; least squares estimation; logistic regressions; Gaussian mixture models; genetic algorithms; simulated annealing; decision trees; projective likelihood; k-nearest neighbor analysis; function discriminant analysis; predictive learning via rule ensembles; natural language processing, state machines; rule systems; probabilistic models; expectation-maximization; or hidden and maximum entropy Markov models. Other methods of matching information in the job description to information of one or more potential candidates for the position may be understood and may be used, as may be desired.

In an exemplary embodiment, the system may also generate, or may alternatively generate, one or more search strings for manual candidate searching, which may be used in, for example, a sourcing step 2. This search string may be or may include keywords targeted at identifying the candidate profiles that best match the job description. In some exemplary embodiments, a plurality of search strings may be generated, each of the search strings having broader search parameters than the search string previously used; in other exemplary embodiments, such search strings may be generated on demand if, for example, too few candidates are found using a narrower search string. In some exemplary embodiments, this gradual broadening may serve to limit the number of irrelevant résumés considered by the system, and help ensure that the résumés available to the system are as relevant as possible to the posting or at least to the search string generated based on the posting. In an exemplary embodiment, in each search string, the values used in the search string and the number of parameters used in the search string may be determined manually or automatically by the system, based on settings such as the weight of importance of one parameter or value over another parameter or value (or combination thereof).

According to an exemplary embodiment, the system may also handle formatting and submission of the job description for posting on one or more locations, such as on a job board or on a social media website. In some embodiments, formatting and submission of the job description may be tailored to the intended recipient or intended site on which the job description will be posted; for example, according to an exemplary embodiment, a more detailed version of the job description may be posted on a jobs board, and a less detailed version (that may refer applicants to another posting, such as the jobs board posting, if desired) may be posted on a social media web site.

In a next step 14 of a job entry step 1, the system may automatically provide the posting to one or more job boards, social media resources, or other advertising resources, such as may be desired, so that the posting can be posted. Job boards may include, for example, DICE.COM or MONSTER.COM. Social media resources may include, for example, LINKEDIN.COM or FACEBOOK.COM. Other advertising resources may include, for example, GOOGLE ADS or other internet advertising services.

In an exemplary embodiment, posting may be performed automatically by the system on those job boards, social media resources, or other locations where automatic posting is permissible. In some exemplary embodiments, this automation process may include, for example, making requests to particular candidates to connect on social media websites, if desired. In an exemplary embodiment, posting may be performed manually on those job boards, social media resources, or other locations in which automatic posting is not permissible or is not well supported. In an exemplary embodiment, the system may have one or more priority algorithms that govern the priority with which it makes posts on particular resources. For example, according to an exemplary embodiment, a system may first post on a designated list of job boards, then post on social media, then purchase one or more ads from an ad service to advertise the posting to a wide market. The system may then generate one or more posts to be manually posted on one or more services, if desired, or may generate a list of one or more services on which posts must be manually written.

In a last step 15 of a job entry step 1, the system may function to maintain the postings that it has made. For example, according to an exemplary embodiment, the system may be configured to receive new job description information and may be configured to update the job descriptions that it has posted, or any other applicable job descriptions, in order to keep the job posting information up to date.

According to an exemplary embodiment, the system may also function to maintain what postings are visible. For example, in addition to making posts, it may be desired for the system to remove posts from one or more services, for example if a given position has been filled or if a sufficient number of apparently acceptable candidates has been found and the candidates are set to be interviewed. The system may also be configured to deactivate and/or reactivate posts, such that they are still stored on the service but are not visible when deactivated, and such that they are visible when reactivated. The system may also be configured to change the visibility of posts, if, for example, requirements change or the job posting has gone a long time without a sufficient number of applications being filed or without a sufficient number of high quality applications being filed. The system may also be configured to refresh the visibility of posts, where applicable; for example, on some services, posts may be displayed on the service in a ranked order based on the last activity that has taken place on the post, and it may be necessary to periodically bump or refresh the post in some way in order to enhance its visibility.

In some exemplary embodiments, some services may not support automatic maintenance of posts, just as some services may not support automatically making posts. In such embodiments, such maintenance may have to be performed manually instead. In an exemplary embodiment, the system may be configured to automatically generate a list of posts that cannot be automatically maintained and which have to be manually maintained. The system may also be configured to generate an indication of the type of maintenance (for example, modification of the post, activation of the post, deactivation of the post, or another kind of maintenance, as may be desired) that must be performed manually. In some embodiments, the system may be configured to provide an amended post that may be used as a guide for making the appropriate manual amendments to the post; for example, in an exemplary embodiment, when the system is provided with up-to-date information about the job posting, it may automatically generate amended posts for one or more services, the amended posts having the proper up-to-date information.

In an exemplary embodiment, maintenance of the posted job state and status on one or more external resources may be maintained automatically according to the priority algorithm. The priority algorithm may take into account factors such as, for example, the date of the original posting, the deadline by which it is desired to have hired a candidate for the position, the current hiring progress, other priorities and internal schedules or deadlines of the client, or any other considerations and conditions.

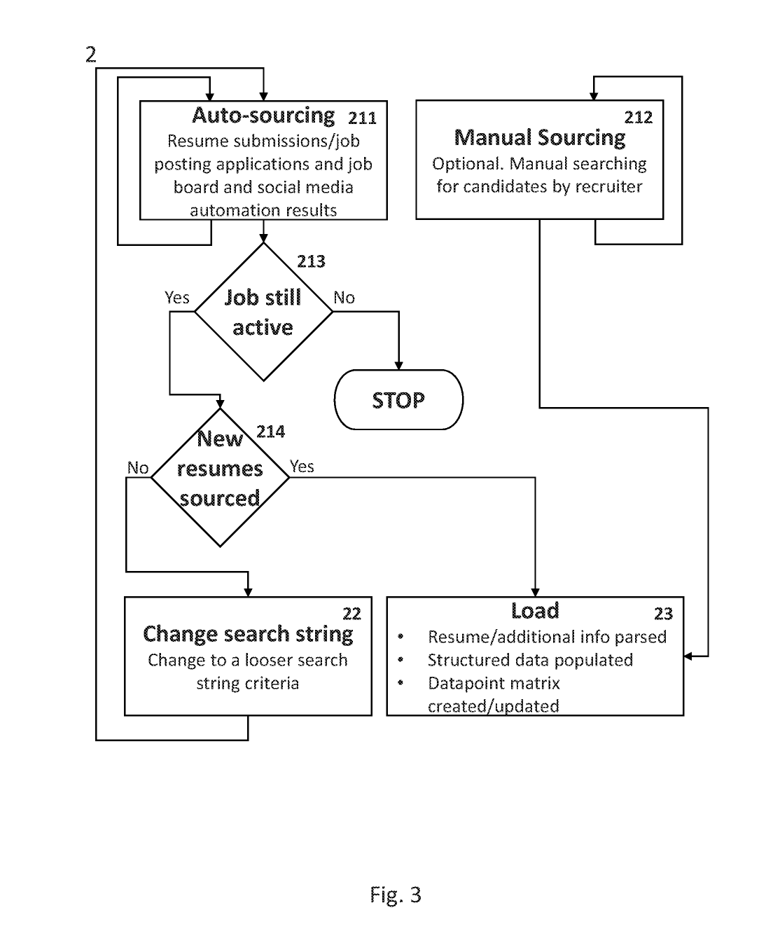

Turning next to exemplary FIG. 3, FIG. 3 displays, in more detail, an exemplary embodiment of a flowchart depicting a method of performing a sourcing step 2. According to an exemplary embodiment, a system may receive inputs from automatic sourcing 211 and manual sourcing 212, and may in each case load résumés into the system in a loading step 23.

According to an exemplary embodiment, in an automatic sourcing step 211, candidates and résumés of candidates may be sourced automatically from job boards and from social media, as well as any other appropriate sources (such as, for example, résumés submitted by a candidate to an employment page of a company website, which may, for example, be forwarded to the recruiter for review). In a manual sourcing step 212, which may be optional in some exemplary embodiments, a recruiter may supplement automatic sourcing 211 by manually searching for candidates and performing traditional sourcing steps. In some exemplary embodiments, sourcing may be entirely optional; under some circumstances, sufficient numbers of résumés may already be on file to allow a desirable number of candidates to be retrieved from candidates already in the system, and as such it may not be necessary to source any additional candidates.

In an exemplary embodiment, automatic sourcing 211 may proceed as follows. In a first step, the system may determine whether the job that is to be automatically sourced for is still active 213. If the job is not still active 213, the system may stop performing the automatic sourcing 215. However, if the job is still active, the system may attempt to source a number of new résumés 214. If the system is able to source a desired number of new résumés 214, the information in the résumés, as well as any other accompanying information, may be passed to a loading step 23. If the system is not able to source a desired number of new résumés 214, the system may change the search string that it is using to perform automatic sourcing 22, such that it is using looser search string criteria. This may entail, for example, broadening the search parameters used in the search string; for example, in an exemplary embodiment, the system may search for a search string containing a plurality of desired skills and desired job titles, and each successively looser search string may have one fewer skill or job title. Other loosening parameters may include, for example, expanding the permissible distance between candidates and the job location (for example, from a radius of 50 miles to a radius of 100 miles; alternatively, a permissible distance could be eliminated entirely and candidates could be asked if they wish to relocate), expanding the permissible date range of the candidate's last activity on a job board or social media profile (for example, in a first case, candidates who have updated a job board posting or social media profile within the past two weeks may be identified as being the likeliest to be looking for a new job and may be selected, while in a second case, candidates who have updated a job board posting or social medial profile within the past month may be selected), Other methods of loosening the search string may also be envisioned. In some exemplary embodiments, the system may provide assistance with manual sourcing 212, which may be performed similarly; however, according to an exemplary embodiment, the system may merely create one or more exemplary search strings that a user can use to search one or more search engines, and may not automatically perform searching 211 with the search strings that it has generated.

In some exemplary embodiments, the system may be configured to generate search strings and perform searching 211 for tasks other than sourcing candidates. For example, according to an exemplary embodiment, the system may be able to look up any information that may be available on the web in order to improve candidate engagement, or limit the number of questions that have to be asked to the candidate if the candidate is considered to be a relatively close match for the position. For example, according to an exemplary embodiment, a job description requirement may require a candidate to have experience with database software, and the candidate's résumé may mention skills with particular software that have not been associated as “database software” by the AI BOT. (For example, the candidate's résumé may mention using GOOGLE database products, such as CLOUD SQL, CLOUD BIGTABLE, and CLOUD DATASTORE, that have been relatively recently released to the public, and these database products may not be recognized as such by the AI BOT.) The AI BOT may generate a search for software or other skills that it does not recognize in order to fill in the gaps in its knowledge, or may generate a search string that would allow a recruiter or technician to fill in these gaps in its knowledge and add the appropriate associations. This functionality may also be used to improve candidate engagement or otherwise support the hiring process in other ways. For example, in an exemplary embodiment, the AI BOT may search for a famous quotation that the candidate has displayed on their social media profile and comment on it, or may search for personal information or personal news provided on a candidate's social media profile and comment on it. For example, in an exemplary embodiment in which the candidate has just taken a trip to Jamaica and posted photographs on their social media page, the AI BOT may view these photographs and ask how the candidate's trip went. In another exemplary embodiment, the AI BOT may view a professional social media posting of a candidate (such as an article the candidate has posted on LINKEDIN) and may comment on it. In another exemplary embodiment, the AI BOT may filter through junk data that the candidate has posted in an attempt to fool or filter out bots or uninformed recruiters; for example, if the candidate has posted nonsense words or nonexistent programming language certifications in order to see if a recruiter is technically savvy enough to comment on them, the AI BOT may identify these through searching, or if the candidate has used a form paragraph of keywords in order to artificially enhance the visibility of their résumé, the AI BOT may perform searching to identify this form paragraph or its source. In another exemplary embodiment, the AI BOT may perform vetting of a candidate through searching; for example, in an exemplary embodiment, the AI BOT may search corporate staff directory pages in order to verify that a candidate was employed at a corporation during a particular time.

The AI BOT also may search for information other than candidate information, and may search based on information other than what has been posted by the candidate, in order to increase candidate engagement. According to an exemplary embodiment, the AI BOT may search an employer's website or certain parts of the employer's website in order to find information relevant to the candidate and which has been left out of the job description provided to the candidate; this information may then be used in order to supplement the information provided in the job description. For example, the AI BOT may search for company benefit information, such as stock option offerings. In another exemplary embodiment, the AI BOT may search external sites, such as external review sites like GLASSDOOR.COM, or external salary comparison sites such as SALARY.COM, in order to improve the engagement of the candidate and improve their interest in a position or company. For example, in one exemplary embodiment, the AI BOT may search GLASSDOOR.COM in order to retrieve favorable reviews of a company, which may then be provided to the candidate. In another exemplary embodiment, the AI BOT may search SALARY.COM or call SALARY.COM's API in order to get information on what candidates with similar experience to the position being hired for are making (or may do the same for the candidate's current position in order to persuade them that they are underpaid in their current position, making them more likely to change jobs). In another exemplary embodiment, the AI BOT may check trending news information about a company, or trending social media information related to a company, and may share any exciting or favorable information.

According to an exemplary embodiment, an initial search string generated for use in either an automatic sourcing process 211 or a manual sourcing process 212 may include, for example, all of the skills and job requirements that were mentioned in the job description or otherwise provided by a hiring manager. The initial search string may further include, for example, one or more job titles that match the job description. For example, an initial search string for a software engineering position for a company with a codebase largely in a particular language might include the title “senior software engineer,” optionally may be further refined by adding the language proficiency desired by the company directly to the title (for example, “senior Python engineer”), and may include a list of skills such as proficiency in the Python language. During a loosening process, optionally, more than one job title could be added; for example, according to an exemplary embodiment in which an initial title used in an initial search string was “senior Python engineer,” the additional titles “senior engineer” and “senior developer” could be added. During a loosening process, skills could also be removed, either instead of adding titles or in addition to adding titles; as such, looser search strings may progressively have more job titles and fewer skills. Skills may also be made optional; for example, for a particular position, it may be most desirable that a candidate for a senior developer position have proficiency in both the Python and Java languages, but acceptable if they have proficiency in either one, and as such a first search string may be generated requiring each of these skills and a second search string may be generated requiring one skill or the other.

In an exemplary embodiment, sourcing, whether automatic 211 or manual 212, may constitute active searching for candidates that match the general criteria for the job opening, as well as accepting submissions and applications from interested candidates via any of the commonly available communication channels, which may include (but which may not be limited to) a Web portal, email, a telephone (including, for example, mobile, landline, and SIP phones), fax/facsimile, SMS text messaging, social media posts or notifications, push notifications, device-based messaging such as VIBER or WHATSAPP, or any other method of communication. In particular, a method of communication that lends itself to automation may be employed in an auto-sourcing step 211, while a method of communication employed in a manual sourcing step 212 may not have to be (and may include, for example, methods like face-to-face networking).

According to some exemplary embodiments where a telephone or other voice-based method of communication is used (or if any other non-text method of communication is used), the system may be configured to load in data interpreted from text, such as, for example, the name of the candidate and the job that the candidate is referring to. This may mean that, for example, if the candidate picks up the phone and calls the recruiter by looking at the number on an incoming SMS text message, the candidate may be referred to an AI BOT that will know this information or other information (such as previous questions asked by the candidate, previous communications with the candidate, and so forth) and will be able to have a conversation with the candidate. In some exemplary embodiments, the same rules as are used for a text-based conversation may be used, or a variation of these rules may be adapted for the telephone conversation, such as may be desired. In some exemplary embodiments, the voice-based conversation or other non-text conversation may be transcribed and stored in the database during or after the conversation; in some exemplary embodiments, the real-time transcription and storage of the conversation and real-time text-to-speech generation may allow the same logic as would be used for a text-based conversation to be used with the added steps of the conversation being recorded in textual form and then output in text-to-speech form.

For example, according to an exemplary embodiment, if a candidate should call a number associated with an AI BOT, for example by reading the number off of an SMS text message or other similar message, or through placing a call through an app that allows such calling (such as SKYPE or FACEBOOK MESSENGER), the AI BOT may respond as follows. “Hi Jim! I'm guessing that you are calling about the job opportunity I emailed/texted you about?” The AI BOT may then wait for a response from the candidate, and may then reply to that response, such as, for example, with “Great! Do you have any questions I can answer for you, or would like me to give you more information on the company or job description?” In some exemplary embodiments, the AI BOT may also be proactive about placing outbound calls to candidates, for example if an email or SMS-based inquiry is not responded to within a certain period of time; for example, an AI BOT may be configured to place a call to the candidate and say “Hi Bill, this is Brian. I was calling about a job opportunity that you might be interested in. Is this a good time to talk?”

In some exemplary embodiments, this may extend to having multiple AI BOTs or multiple instances or personas of the AI BOT. This may ensure that, when the AI BOT converses with a candidate, the “from” number does not need to be the same for all candidate text communications, which may better facilitate two-way communications. This may also simplify the process of transferring the conversation to a live recruiter.

For example, according to an exemplary embodiment, each of the recruiters of a recruitment agency may be paired with one or more AI BOT personas, which may each have different voices or personalities or any other variances that may be desired. According to one exemplary embodiment, each of these voices, personalities, or other attributes of the AI BOT persona may be based on the attributes of the recruiter in order to ease any transition that needs to be made between the AI BOT and the live recruiter, if such is desired. So, for example, if a recruitment agency has 30 recruiters, according to an exemplary embodiment, 30 instances of the AI BOT may be generated, each having a different name (which may be, for example, the name of a recruiter, or may be another name, such that the bot can be represented as the recruiter's assistant or staff member), each having a different telephone number, each having a different email address, and each having any other different information. This may help to individualize a communication with a particular candidate, or individualize a particular offer made to a particular candidate; for example, in an exemplary embodiment, a candidate who is approached more than once by the same recruiting agency may have different AI BOT personas that communicate with them each time, if this is desired. Alternatively, it may ensure that the same AI BOT personality communicates with the same candidates each time, but that this AI BOT personality does not necessarily communicate with every candidate, in order to give the candidate the impression that they have been partnered with a particular recruiter. In some exemplary embodiments, candidates may be paired with certain AI BOT personalities based on some criteria, such as feedback provided by the candidates or candidate demographic information.

In some exemplary embodiments, it may be desired to have separate instances of the AI BOT for different communications media. For example, according to an exemplary embodiment, an AI BOT instance or persona may have a specific phone number or email address, and a separate instance of the AI BOT may be used for other services, such as FACEBOOK MESSENGER, WHATSAPP, or SLACK, or any other services that may be desired. In some exemplary embodiments, a separate instance of the AI BOT may exist for all AI BOT instances—for example, such that, for each recruiter, there may be both a standard bot and a WHATSAPP/FACEBOOK MESSENGER bot—while in other exemplary embodiments just one AI BOT may exist for each alternative service, such as may be desired.

In an exemplary embodiment, automatic sourcing may be performed on those job boards, social media resources, and other resources that allow automation, and manual sourcing may be performed on those job boards, social media resources, and other resources that do not allow automation. In some embodiments, manual sourcing may also be performed, to a limited degree, on those job boards and other resources that do allow automation, in order to confirm the results of the automated process, if desired.

In both automatic 211 and manual 212 sourcing, each sourced candidate may be associated, within the system, with the job that they are being sourced for. In some exemplary embodiments, candidates may be sourced to particular jobs or may be simultaneously sourced to more than one job, as desired.

In a loading step 23 of a sourcing step 2, a résumé (including a CV/résumé document or any other information) of a sourced candidate or of more than one sourced candidate may be input into the system, and may be parsed. In an exemplary embodiment, the system may, in a parsing step, identify one or more concepts in the résumé, contact information of the candidate, the experience of the candidate, and any other relevant key points that may be applicable to the hiring of the candidate. The parsed data may then be structured and stored in a database.

In an exemplary embodiment, a data-point matrix may then be created for each résumé. According to an exemplary embodiment, a data-point matrix may be created for each résumé for each subsequent matching and ranking of that résumé. In some exemplary embodiments, a data-point matrix may already exist for a particular résumé (for example, if the sourced résumé is an update of a previously-provided résumé for a particular candidate); in such exemplary embodiments, the data-point matrix may already exist in some form and may be updated rather than created.

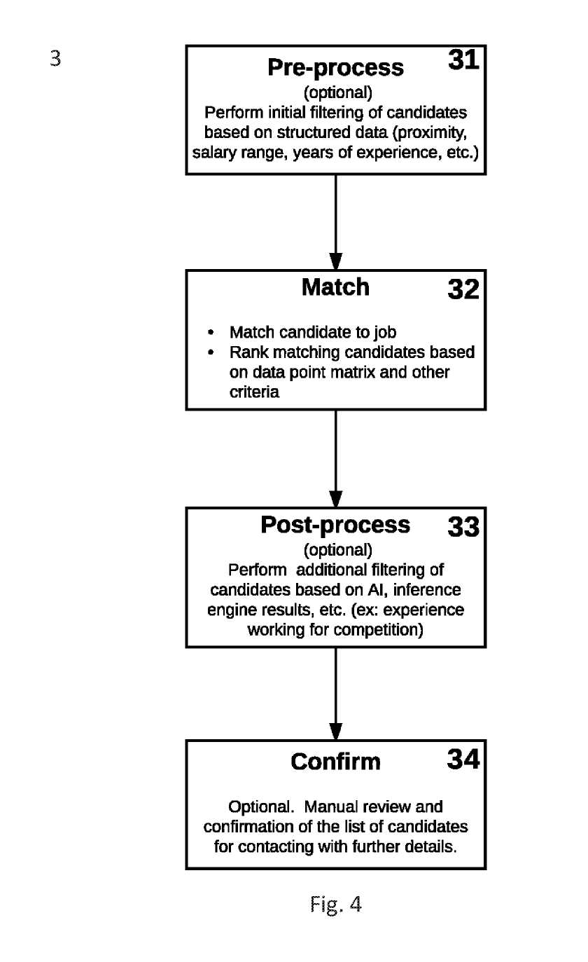

Turning now to exemplary FIG. 4, FIG. 4 displays an exemplary embodiment of a matching step 3. In a matching step 3, the system may attempt to match job candidates to jobs. This step may include, for example, a pre-processing step 31, a core matching step 32, a post-processing step 33, and a confirmation step 34. In an exemplary embodiment, each of the steps apart from the core matching step may be optional; for example, in some exemplary embodiments, these steps may be enabled or disabled based on the candidate search to be performed, or may be enabled or disabled for a particular system. Further, in an exemplary embodiment, the criteria used by each of the pre-processing step 31, core matching step 32, post-processing step 33, and confirmation step 34 may be weighed in order to ensure the best possible matches, and may be dynamically adjusted (in terms of weight and in terms of which criteria are actually applied) in order to loosen or tighten the focus of a search.

In an exemplary embodiment, a matching method 3 may be triggered following a sourcing step 2. However, in an exemplary embodiment, matching 3 may be a continuous process, which happens alongside a sourcing step 2, such that matching 3 is performed on newly sourced résumés as they are sourced. For example, according to an exemplary embodiment, a matching step 3 may be triggered by the addition of a new résumé by a user of a jobs board or other source location, an updated résumé being provided by the user of a jobs board or other source location, the addition of a new job on a jobs board or other source location (such as, for example, via email or by the use of an Applicant Tracking System (ATS)) by an employer, an update to a job description being provided on a jobs board or other source location by an employer, or any other addition or alteration to a résumé or a job description on a jobs board or other source location. In some exemplary embodiments, a matching step 3 may also be performed again if a review step 7 is reached and the hiring manager rejects some or all of the candidates that have been provided to the hiring manager; for example, according to an exemplary embodiment, matching 3 may be performed when a rejection is received, or may be performed when feedback is received from the hiring manager (for example, one or more reasons as to why a candidate was rej ected for an interview), which may be done in order to encourage the hiring manager to provide feedback. Finally, in an exemplary embodiment, matching 3 may be triggered before a sourcing step 2; for example, according to an exemplary embodiment, existing candidates having existing candidate profiles stored in a database may be matched 3 before other candidates are sourced in a sourcing step 2. In some exemplary embodiments, a system may be configured to perform matching 3 either before, during, or after sourcing 2; for example, in an exemplary embodiment, a system may assemble a database of candidates for a first position by performing sourcing 2 and then matching 3, and may then match 3 the same database of candidates to a similar second position before performing additional sourcing 2. A system may likewise perform matching 3 for a particular position before, during, and/or after sourcing 2; for example, according to an exemplary embodiment, a new position to be filled may be provided by a hiring manager, and a matching 3 process may begin immediately using the existing candidate profiles stored in the database. Sourcing 2 may then be performed, and as new résumés come in (from sourcing 2 for this position or sourcing 2 for another similar or related position) the matching 3 process may run again on these candidates. (Likewise, the matching 3 process may run again when updated data is received on existing candidate profiles.)

According to an exemplary embodiment, a system may be configured to automatically receive notifications of a user having added their résumé or having updated their résumé, or a job description being created or edited; for example, such a system may be tied into the operations software of a jobs board or source location. In an exemplary embodiment, a system may be configured to automatically perform searches for users having added a résumé or edited a résumé, or employers having added or edited a job description. In an exemplary embodiment, a system may exhibit different behaviors for users who are part of active campaigns (i.e. users who are considered to be candidates for at least one job) and users who are not; for example, in an exemplary embodiment, users who have been identified as being candidates may be monitored more closely, if desired.

In an exemplary embodiment, the conversion of résumé data and job description data into data point matrices, or data sets (such as data vectors) on a data point matrix, may be used to store both all of the data entities contained by the system and all of the relationships between the data entities contained by the system. This may allow all résumés to be cross-referenced with all job descriptions (or may allow a substantial number of résumés to be cross-referenced with a substantial number of job descriptions) with relative ease. As such, in the event that the system fails to match a specific résumé to a specific job, it may be able to repeat a matching step 3 in order to match and suggest other job opportunities that may better suit the candidate, and may be able to repeat a matching step 3 in order to suggest a given candidate to hiring managers having other open positions to the one being presently matched.

In a pre-processing step 31, the system may perform initial filtering of candidates based on some criteria. This criteria may include, for example, any or all types of available structured data, such as proximity, salary range, years of experience (such as, for example, years of experience in general or years of experience with a specific skill), or any other available data. For example, it may be desired to, as part of a pre-processing step, sort out all candidates who are not within a 50-mile radius (or within an estimated 1-hour drive) of a job site. In another example, it may be desired to filter out all candidates having a salary known to be in excess or significantly in excess than a salary of a position being offered (or who can be estimated to have a salary in excess of the position being offered based on their job title).

The system may then perform a core matching step 32, in which the system may attempt to match candidates to jobs. In an exemplary embodiment, the system may perform a search for candidates using a semantic matching engine; in an alternative embodiment, the system may perform a search for candidates using any other searching method or searching tool, instead of or in addition to a semantic engine. The semantic engine may be a natural language processor capable of inferring meaning relevant to a particular subject from literal statements in a quasi-analog manner, often by analyzing the context of a literal statement and how the statement relates to other words or statements. The semantic engine may be or may include an artificial intelligence (AI), machine learning software, natural language processing software, or comparable software or hardware, such as may be desired. The résumés of searched candidates may be scored based on their match to one or more elements extracted from the job description, which may include one or more key points, concepts, or requirements that are outlined in the job description.

According to an exemplary embodiment, as part of the matching step 32, the résumé of a candidate may be matched to more than one job. For example, in an exemplary embodiment, a data point matrix may include multiple data sets, such as data vectors, which each represent the requirements of a job. This may mean that, even if the system fails to match the candidate to one particular job, the system may be able to match the candidate to a different job based on the data set of the second job and its similarity to the data point matrix of the résumé.

In an exemplary embodiment, as part of the matching step 32, searching (using a semantic engine or otherwise) may be performed on those résumés sourced for the job in question. In another exemplary embodiment, searching may be performed on all candidate résumés that exist in the system, with résumés that have been sourced specifically for the job in question being given a higher priority in the search, if desired. In another exemplary embodiment, searching may by default consider all résumés, but may exclude résumés in cases where the candidate associated with the résumé has selected an option to strictly associate the résumé with a particular job (for example, if the candidate has selected an option not to be considered for other jobs). In another exemplary embodiment, searching may by default consider only those résumés sourced for the job in question, but may include résumés in cases where the candidate associated with the résumé has selected an option to allow the consideration of the résumé for any applicable job or for a broader set of applicable jobs.

In an exemplary embodiment, résumés may be scored by a semantic engine utilizing machine learning concepts. The semantic engine may apply weight to certain requirements, which may be specified by a hiring organization or recruiter or may be derived from the job description. For example, these requirements may include (but may not be limited to) a title search (i.e. a search of job titles), the date on which the résumé was last updated, particular skills (or synonyms of those skills) that may be listed in the résumé, a number of required years of experience in a particular field, a number of required years of experience in a particular industry, a number of years of experience associated with a skill or with a particular set of skills, employment continuity, salary history, salary requirements, geographical proximity, social footprint (for example, the connections of the user on one or more social media websites), activity of social media (for example, the postings of the user on one or more social media websites), willingness to relocate, and any additional requirements that have been provided by the hiring company or which have been deemed relevant to the process. In an exemplary embodiment, some or all of these criteria may be given different levels of weights from one another. In an exemplary embodiment, particular criteria may be mutually exclusively given weight, or may weigh against each other; for example, if a candidate is found who is geographically proximate to a hiring company, it may not matter that the candidate is willing to relocate, and the willingness of the candidate to relocate may not be scored or may be given different weight.

The semantic engine may then determine which candidates have the highest scores, and may select candidates accordingly. For example, in an exemplary embodiment, a semantic engine may rank candidates based on the data point matrix scores of the candidates in each of the above areas (or in each of the above areas that are actually considered) and based on any other criteria, as desired. The semantic engine may then use the ranked list of candidates to select one or more candidates to progress to a next stage of hiring; for example, in an exemplary embodiment, the semantic engine may take the top X most highly ranked candidates.

In an exemplary embodiment, to facilitate searching (using a sematic engine or otherwise) during a matching step 32, the search functionality of the system may be configured to be iterative in nature and may broaden with subsequent iterations, similar to the automatic sourcing search 211 performed in the previous step 2. For example, in an exemplary embodiment, if the system performs a search for candidates that score above a pre-set primary threshold, and is unable to identify a particular prerequisite number of candidates for the position which score above that threshold, the system may perform a new search with looser search criteria, such as a pre-set secondary threshold or an automatically calculated secondary threshold. In an exemplary embodiment, the system may be configured to continue this until the prerequisite number is identified; in another exemplary embodiment, the system may terminate the searches after a specified number of times or after reaching a specific threshold.

In an exemplary embodiment, the system may be configured to loosen or deprioritize particular search criteria first. For example, according to an exemplary embodiment, the system may be configured to first loosen search criteria based on the considerations of geographical proximity, skill set, years of experience, salary requirements, or any other specifications that might be provided by the hiring company. In an exemplary embodiment, loosening of search criteria may be performed in pre-configured steps (i.e. using a pre-set secondary threshold); for example, if a search is initially performed of candidates within a 20-mile radius, the next pre-set secondary threshold may be candidates within a 50-mile radius, and the one after that may be candidates within a 100-mile radius.

In an exemplary embodiment, candidates may be grouped into a first group, a second group, or any number of other groups based on the relevance of the candidates to the job description, which may be determined by the search results. For example, according to an exemplary embodiment, candidates meeting a primary score threshold may be grouped into a first group, candidates meeting a secondary score threshold but not a primary score threshold may be grouped into a second group, and so on and so forth.

According to an exemplary embodiment, a post-processing step 33 may be performed in order to perform additional filtering of candidates that have been selected as part of a matching step 32. In some exemplary embodiments, a post-processing step 33 may perform filtering by the use of an AI, by the use of inference engine results, and so forth. (According to an exemplary embodiment, an inference engine may be incorporated into the system, which may be used to facilitate post-processing filtering as well as other inferences, such as, for example, inferences about what the intent of the candidate is or is likely to be, that may be useful for post-processing 33.) In some exemplary embodiments, a post-processing step 33 may filter based on any criteria, including criteria that have been considered previously or new criteria used only in post-processing filtering.

In an exemplary embodiment, an optional post-processing step 33 may filter candidates based on positive criteria that positively distinguishes the candidate seeking employment over other candidates, negative criteria that is detrimental to the candidate seeking employment, neutral criteria, or criteria that can be or is more than one of the above. For example, in an exemplary embodiment, a candidate may be filtered based on the candidate's experience working for a firm that competes with the firm that has the job opening. This may be considered to be a positive criterion (the candidate may have insight into the workings of the competitor) and the candidate may be filtered for that reason; conversely, it may be considered to be a negative criterion (the candidate may be subject to an undesirable post-employment agreement with the competitor) and the candidate may be filtered for that reason. In some exemplary embodiments, a post-processing step 33 may remove filtered candidates or may change the group into which a filtered candidate may be placed, as may be desired.

Lastly, according to an exemplary embodiment, an optional confirmation step 34 of a matching step 3 may be performed after a post-processing step 33 or after a matching step 32 if a post-processing step is not performed. In a confirmation step 34, depending on the configuration of the system, a final list of matching candidates may be provided by the system, for example to a recruiter and/or to the hiring company, in order to permit manual review and confirmation of the final list by either or both of the recruiter and the hiring company. In an exemplary embodiment, this step may take place prior to initiating contact with the candidates. In an exemplary embodiment, the system may be configured to automatically initiate contact with the candidates once they have been identified, but may not receive authorization to do so until the confirmation step 34 is completed.

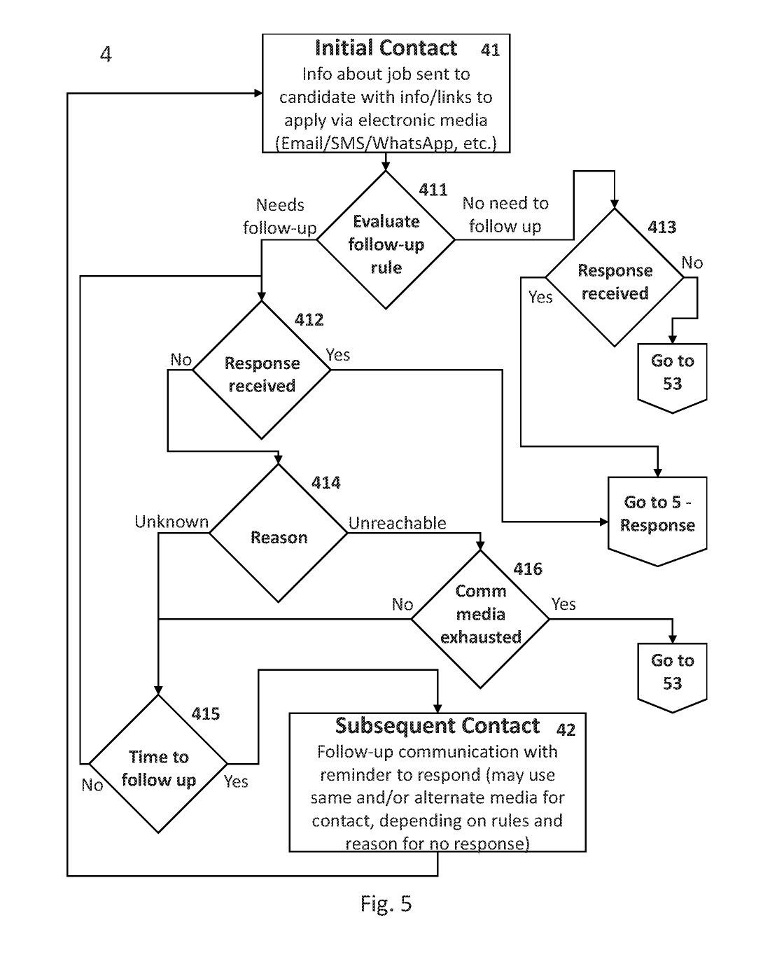

According to an exemplary embodiment, after a confirmation step 34 is completed (if it is desired to perform one) or after the matching step 3 is completed, the system may perform a contact step 4. This may be shown in, for example, exemplary FIG. 5. According to exemplary FIG. 5, in a matching step 4, the system may automatically initiate a communication campaign to the one or more candidates identified by the search.

The system may first perform an initial contact step 41, in which information about the job is sent to a candidate, along with a link enabling the candidate to apply for the job, via some form of electronic media or otherwise. After an initial contact 41 has been sent, the system may then evaluate a follow-up rule 411, in order to determine whether the system has a need to follow up on the initial contact. For example, according to an exemplary embodiment, the system may determine that it has a need to perform additional follow-up communications if the candidate is a high-priority candidate who appears to be particularly suited for a position, if there are few other candidates being considered for the position, or if the system has otherwise been instructed to perform follow-up via a follow-up rule 411. In an exemplary embodiment, the system may determine that it does not have a need to perform additional follow-up communications if the candidate is a lower-priority candidate or if the system has otherwise been instructed not to perform follow-up via a follow-up rule.

According to an exemplary embodiment, the follow-up rule 411 may be configured to induce the system to send reminders to the candidate when the candidate has not responded to an inquiry, or when the candidate has responded to an inquiry but further information is necessary. For example, according to an exemplary embodiment, a system may determine that it is necessary to get an updated résumé from a particular candidate, and the system may have received an email communication from the candidate promising that the candidate will send the updated résumé later in the day. The next day, the system may determine that it has not received the updated résumé, and may send a communication to the candidate reminding the candidate to provide the update résumé.

In an exemplary embodiment, the follow-up rule 411 may also be configured to induce the system to rephrase its inquiries between the initial communication with the candidate and one or more follow-up communications provided to the candidate. For example, according to an exemplary embodiment, an AI BOT may ask a candidate a first question about a specific skill listed on the candidate's résumé, such as, for example, the candidate's skill with artificial neural networks. The candidate may not respond to the question, which may prompt the AI BOT to ask the same question to the candidate after a given period of time has passed, with the question optionally being rephrased if this is desired. For example, the system may first ask the question “Do you have experience with artificial neural networks?” and may ask in a second question “I believe you do have experience with artificial neural networks because ‘cognitive science-based machine learning’ is listed in the skills section of your résumé, but can you confirm that this is true?” If there is still no response, the AI BOT may be configured to skip this question and move onto a later one, optionally providing this question again after a number of other questions have been asked, such as at the end of a process.

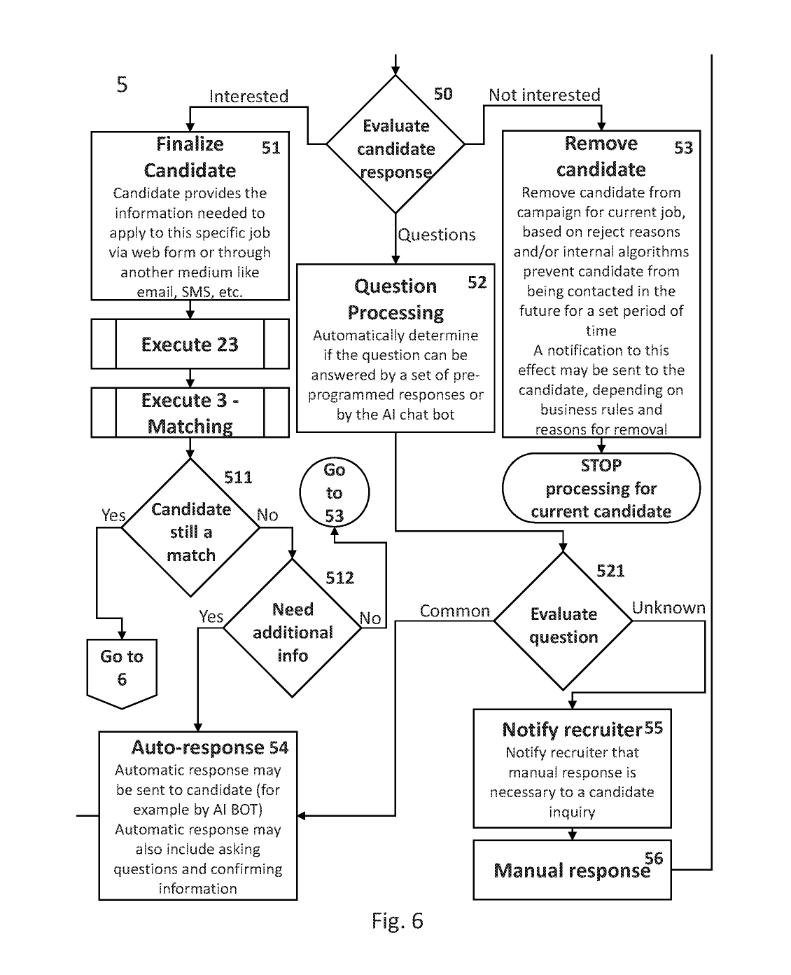

If there is no need for a follow-up communication established by a follow-up rule 411, then the system may determine whether a response has been received 413. This may be done, for example, periodically, when every new communication is received, or otherwise, as may be desired. If a response is received, the system may proceed to step 5, a response step, which may be indicated in exemplary FIG. 6. If no response is received and some criteria is met (for example, if no response has been received for a designated period of time, or if no response is received by the time a certain number of other candidates have responded, or if no response has been received for a certain period of time after at least one other candidate has responded, or otherwise, as may be desired) the system may proceed to a step of removing the candidate 53.

If there is a need for follow-up communication established by a follow-up rule 411, then the system may likewise determine whether a response has been received 413. This may be done for example, periodically, when every new communication is received, or otherwise, as may be desired, using similar logic to the “no need for follow-up communication” case or using different logic (for example, the “need for follow-up communication” case may use a shorter time period, if desired). If a response is received, the system may likewise proceed to step 5.

However, if no response is received, then the system may consider whether executing a follow-up response is necessary. In a first step, when no response has been received, the system may attempt to determine the reason as to why no response has been received 414. For example, the system may be configured to determine whether no response has been received for the reason 414 that the candidate is unreachable by the candidate's posted contact information; for example, an attempt to make a phone call to the candidate may result in a message that the call cannot be completed as dialed, an attempt to send an email communication to the candidate may result in a bounce message, or an attempt to send a physical letter to the candidate may result in a “return to sender” notification. In such a case, when the communication media that is accessible to the system has been exhausted 416 and it does not appear that the candidate has been successfully contacted, the candidate may be removed from consideration 53. However, if other communication media are identified that have not been exhausted, the candidate may be contacted by said communication media.

The system may also conclude that it is not able to identify a specific reason as to why the candidate has not responded 414. In such a case, the system may determine that a follow-up communication should be drafted 415. According to an exemplary embodiment, upon making such a determination, the system may initiate a subsequent contact 42. In some exemplary embodiments, the subsequent contact 42 may be a follow-up communication that indicates its status as a follow-up communication, and provides a reminder to respond. The system may make use of the same media initially used to make contact or may make use of alternate media to make contact, such as may be desired; this may be based on, for example, the rules of the system, the reason for no response if one can be determined, the candidate's expressed preferences if any have been expressed (for example, the candidate's profile on a job search website may indicate a preference to be contacted by email) or any other logic such as may be desired. In an exemplary embodiment, the messages that may be sent may be tailored to the communications medium used to send the messages; for example, according to an embodiment where a text message and an email are sent to a candidate simultaneously, a text message communication may be a short message containing only essential details (or may even be a notification that an email was sent) and an email communication may be a more detailed communication, as may be desired. Messages sent via the same or a different communications medium may be sent sequentially or simultaneously, as may be desired.

Once a follow-up communication has been sent in a subsequent contact step 42, the system may proceed back to near the start of the method 4. For example, the system may then be configured to determine whether future follow-up is necessary based on a follow-up rule 411; for example, in some cases, it may be desirable to send only one follow-up communication to a candidate, whereas in other cases it may be desirable to send more than one follow-up communication to a candidate.

The system may perform similar steps for every candidate or for more than one candidate, and may proceed through a list of candidates in some order. For example, in an exemplary embodiment, the system may proceed by residency group affiliation or otherwise may proceed by rank; for example, in an exemplary embodiment, a system may contact candidates who scored above the primary score threshold first (in any order) and may contact candidates who scored above the secondary score threshold next (in any order). In another exemplary embodiment, the system may proceed in any order.

According to an exemplary embodiment, the system may, as part of the communication campaign, send a variety of types of information to candidates. This information may include, for example, periodic updates about the status of their application to the position, reminders about what next steps the candidate needs to take or reminders about future appointments (or any other applicable reminders), requests for further information from the candidate, or any other communications, as may be desired.

In an exemplary embodiment, the system may make use of one or more varieties of channels of communication, which may be used on their own or in any combination. These may include (but may not be limited to) a Web portal, email, a telephone (including, for example, mobile, landline, and SIP phones), fax/facsimile, SMS text messaging, social media posts or notifications, push notifications, device-based messaging such as VIBER, FACEBOOK MESSENGER or WHAT SAPP, or any other method of communication.

According to an exemplary embodiment, the system may be configured to treat each campaign directed at a particular candidate as containing a single thread of communication with the candidate, regardless of whether the same communications medium or a different communications medium has been used in order to contact the candidate in the past. For example, according to an exemplary embodiment, a particular candidate may be initially contacted by telephone, may be sent a follow-up message via email, and may be engaged in subsequent dialogue via SMS text messaging; each of these communications may be combined into a single thread of communications for the candidate, with the system being able to draw on previous communications with the candidate from each of these different sources. In some exemplary embodiments, the system may be configured to send communication requests via first one channel and then another; for example, in an exemplary embodiment, communications requests may be sent first via a “lower-priority” channel such as email where it may not be expected that the candidate will read the communication for several hours, and then may be sent via a “higher-priority” channel such as SMS where the candidate is more likely to be alerted immediately to the communication. For example, according to an exemplary embodiment, the system may, when attempting to alert a candidate of something (such as that the candidate is being requested to indicate their interview availability for the next day) first send a message by email, and then, when the candidate has not responded in a specific period of time (such as a three-hour period) the system may then be configured to send an SMS text message to confirm whether the candidate is available for the interview. If the candidate still does not respond within a certain time period, the system may be configured to place a telephone call to the candidate.

According to an exemplary embodiment, the system, in the contact step 4 and during the execution of the communication campaign, may begin a communication campaign by notifying the candidates of the job opening that matches their résumé, and providing instructions for applying for the position. In another exemplary embodiment, the communication campaign may begin at a later step, if, for example, the candidate already has an application on file for the position or for a similar position, or if the candidate has already expressed an intent to apply.

In an exemplary embodiment, the system may use the rank or relevancy group affiliation of a candidate to determine information other than the order in which candidates should be contacted. For example, according to an exemplary embodiment, the nature of the communication may be dependent on the relevancy group that the candidate is in; for example, a candidate might be “strongly encouraged” to apply for a position to which their résumé is highly relevant (i.e. the candidate has a high relevance score) while the candidate might be provided with the position in a list of potentially interesting positions if their résumé is less relevant (i.e. the candidate has a lower relevance score). The frequency of communication with a particular candidate, the content of the communications, and the choice of communication channels used may also depend on the relevance score of the candidate. In an exemplary embodiment, the system may dynamically adapt the nature of communication, frequency, content, and choice of communication channels based on the progress of bi-directional communication with the candidate; for example, a candidate may be initially contacted by e-mail, and then may be sent an SMS text message or may be called (for example, by an automated calling system) in a later stage in order to set up an interview time (or if the candidate expresses a preference for being contacted by telephone, or if they do not respond to the e-mail within a particular amount of time).

In an exemplary embodiment, the system may continue to perform a communication campaign with a candidate until one of the following conditions is met. First, the communication campaign may stop if the candidate is hired for the position. Second, the communication campaign may stop if the candidate elects to stop receiving further information about the job opening. Third, the communication campaign may stop if the system has been unsuccessful in contacting the candidate; for example, if the candidate has provided an email address and a phone number, and does not respond to communications with either the email address or the phone number, the communication campaign may stop after a certain number of communications have been made. The communication campaign may also stop if a “bounce notice” or other indication of a failed communication is received; for example, if an email receives a hard bounce, or if a notification is provided that an SMS text message did not go through due to having a bad number (or due to the candidate providing a landline number instead of a cell number). Finally, the communication campaign may stop if the position is filled, cancelled, or closed, with the system optionally providing notice of this in a final communication to the candidate. The communication campaign may be affected based on the candidate's response, for example the candidate's open or click rate for messages sent by some form of electronic communication, including but not limited to email, SMS, text chats, social media, or some other method, or the call status of communications with the candidate, or other such responses, if desired.

In an exemplary embodiment, the system may be configured to make use of a semi-automated predictive dialer system for initiating phone calls to one or more candidates. According to an exemplary embodiment, the dialer system may initiate calls to a list of candidates, which may be performed sequentially in some order or may be performed according to other logic, as desired. The dialer system may then determine whether the call has been successfully completed and whether the party at the other end of the line is a live person. When the dialer system determines that the party on the other end of the line is a live person, the dialer system may bridge the call to a recruiter, who may then complete the conversation with the candidate. On the other hand, when the dialer system determines that it has not connected to a live person at the other end of the line (for example, if a voicemail service or answering machine is reached) the dialer system may be configured to leave a message, terminate the call, and move on to the next candidate on its list. In some embodiments, some amount of calls may be performed simultaneously rather than sequentially; for example, the dialer system may be paired with more than one recruiter, and may attempt simultaneous or overlapping calls until all recruiters are in a conversation with a candidate.

Turning now to exemplary FIG. 6, FIG. 6 displays an exemplary embodiment of a flowchart depicting a method of performing a response step 5. In an exemplary embodiment, a communication campaign system may be configured to be bi-directional, such that it can respond to questions and requests for information posed by one or more of the candidates under consideration.

When a candidate has been contacted by some communication channel, and when the candidate responds by some communication channel (which may or may not be the same communication channel as was used to initially contact the candidate, if desired; for example, the candidate may initially be contacted by email and may elect to respond to the contact by calling a telephone number provided in the email) the system may be configured to handle and respond to the candidate's response 50. For example, in an exemplary embodiment, the system may determine from the candidate's response (for example, by parsing an email of the candidate, or otherwise analyzing their response) whether the candidate has responded to the initial contact message provided by the system by accepting an offer provided in the contact message (such as, for example, an offer to apply for a position), by rejecting an offer provided in the contact message (for example, by sending a message declining an offer to apply for a position), or by asking a question or requesting more information.

In some exemplary embodiments, a candidate may also have multiple different responses, such as an acceptance of an offer to apply for a position and a question, or a series of questions. For example, the candidate may express that they are interested in applying for the position, and ask a question about how soon they are likely to be contacted about an interview if they make it past the application stage. In other exemplary embodiments, a candidate may make a single statement or may otherwise provide a single response that has multiple intents.

For example, in some exemplary embodiments, candidates may provide responses that are similar to the following: “Are they willing to pay for relocation? I live in Portage, Mich. Salary range? Is it a permanent role?” or “What is the salary? Is this a perm position? How much time travelling? Hours? How big is the company?” or “It sounds interesting. Do you offer a relocation program? What's the salary?” In such cases, the natural language processing engine or other parsing utility may parse each of these questions or statements separately, and the questions or statements may be analyzed as a whole or individually in order to determine what kind of response should be formulated (and whether, for example, statements provided by the candidate answer any of the questions that would otherwise be asked of the candidate in the response).

For example, in the first statement, the system may parse the information that the candidate has a question of whether the company is willing to pay for relocation, may parse the information that the candidate has provided a statement that they live in Portage, Mich., may parse the information that the candidate has a question as to what the salary range of the position is, and may parse the information that the candidate has a question as to whether the position is intended to be a permanent one. The first question parsed by the system, whether the company is willing to pay for relocation, may under other circumstances prompt a response question to be provided by the system, asking where the candidate lives (so that, for example, it can be determined from a company relocation policy or from analysis of a company relocation budget whether the company would be willing to pay for relocation). However, in this case, a later statement provided by the candidate answers the question that would be asked by the system and provides this detail, so the system may not ask this question to the candidate.

In some exemplary embodiments, the NLP layer or other parsing engine of the system may be provided with a service that breaks up multiple intents and questions and sends them to the NLP layer one at a time. For example, it may be desirable to send each question separately to the NLP layer, such that the NLP layer is first asked a) Are they willing to pay for relocation?, next asked b) I live in Portage, Mich. Salary range?, and finally asked c) Is it a permanent role? The system may interpret each of these requests individually, and may answer, “Yes there is a relocation package, HR will provide you all the details during the interview. The salary range is $80-$110 k, depends on experience. Yes, this is a permanent role.” In some exemplary embodiments, the system may then consider each of these responses in the context of what information had been most recently provided by the candidate; for example, if the salary range for the Portage, Mich. area is on the lower end of the listed salary range, the system may revise its salary estimate to $80-90 k, depending on experience, before sending the response to the candidate.

If the response of the candidate is to indicate interest in a position or an offer, the system may be configured to take action to finalize the candidate 51. In an exemplary embodiment, should the system receive a communication from the candidate indicating that the candidate is interested in the position, the system may send a request for any other remaining required information to the candidate. According to an exemplary embodiment, if interested in the job, the candidate may click on a link provided by the system and may then provide the remaining required information or other information that may be necessary or useful to a hiring decision.

According to an exemplary embodiment, the candidate may be taken to a page containing all of the information that they have already provided, as well as all of the information that is necessary, optional, or requested; on the page, the information that the candidate has already provided or which is otherwise available may be pre-filled, while the other sections of the page may be left blank. In an exemplary embodiment, the candidate may thus be provided with an opportunity to update any or all of the information that they have previously provided, or may be provided with an opportunity to correct erroneous information that has been taken from elsewhere. For example, in an exemplary embodiment, the candidate may be provided with the opportunity to update their résumé, their contact details, their salary requirements, or any other information. Candidates may also be provided with the opportunity to expand upon information that they have provided or which has been retrieved from a candidate profile or elsewhere. For example, a candidate may be able to optionally provide information on the key skills for the position, such as the numbers of years of experience typically required for the position, the last year the candidate used those skills, and/or a description of how the skill was last used. (According to another exemplary embodiment, rather than being directed to a web site and solicited for the additional information via a web form, the candidate may instead be solicited for the additional information through another medium, such as email, SMS, or another such medium as may be desired.)

In some exemplary embodiments, additional screening questions may be added during this step. For example, according to an exemplary embodiment, a candidate may add a new skill or new work experience to a web form when they are directed to it, indicating that the candidate has developed a new skill or new work experience; the candidate may then be further screened based on this new skill or new position, and may, for example, be asked further questions about the new skill or work experience.

In an exemplary embodiment, once a step of finalizing the candidate 51 has been completed, the system may perform a step of loading the candidate's information 23. The step of loading the candidate's information may be similar to, or may use the same logic as, the step of loading and parsing the candidate's résumé information previously executed in method step 2. If the candidate has provided additional information, for example if the candidate has provided additional information other than as a direct response to a question of a web form, this additional information may be parsed. For example, if the candidate has provided additional information in the form of a response to an open-ended question or has provided an email or SMS response rather than a web form response (or has sent a communication via any other communications medium, such as via a telephone call) this information may be parsed and populated in the database. The structured data may then be populated into the data point matrix previously used for the candidate (or, in some circumstances, into a new data point matrix) in order to update the candidate's data point matrix. This may ensure that the candidate's information is completely up to date, and that, if it has been a significant period of time since the candidate's résumé was initially received and the candidate has accumulated new skills or work experience, that the candidate's new skills or work experience (or other changes to their résumé ) are adequately reflected in the data-point matrix.

Once a step of loading information 23 has been performed, the system may perform a step of matching the candidate to one or more positions, which may be done using the matching method of step 3 or may be done using another matching method. The matching method may include a core substep of matching 32, in which the candidate is matched to a job based on the data point matrix and other criteria, and may include one or more other optional steps such as a post-processing step. For example, when the candidate has provided additional information, the candidate's additional information may be filtered based on one or more items of interest for a pre-processing step, such as the candidate's experience working for a competitor; if the candidate's responses indicate that they now have experience working for a competitor when they did not have such experience before, then the candidate may be filtered based on that new experience.

In an exemplary embodiment, a matching method 3 may be triggered by the addition of a new résumé by the candidate to a source location (such as a jobs board) or by updates to a résumé being provided by the candidate to the source location. In some exemplary embodiments, the system may automatically receive notifications of the candidate having updated their résumé: in other exemplary embodiments, the system may be configured to periodically search for candidates that are already part of the campaign, or which otherwise have already been searched, in order to determine if they have recently updated a résumé.

Likewise, in some exemplary embodiments, a matching method 3 may be triggered by the addition of a new job description or changes being made to an existing job description. For example, in the event that a job description is changed, a candidate that has not made any changes to their résumé and who is considered to be relevant to the original job description may still need to be evaluated in order to determine whether or not the candidate matches the new job description.

Following a matching step 3, it may be determined whether the candidate is still a match for the position 511 based on the new information that the candidate has provided. For example, in one exemplary embodiment, a matching step 3 may be configured to filter out candidates who have worked for a competitor, based on the expectation that those candidates may be subject to a non-compete agreement or other burdensome employment agreement. A candidate may provide new information indicating that they are now working for a competitor, indicating that they now may be subject to being filtered out when they would not have been filtered out based on their previous disclosure. (Alternatively, a candidate may indicate that they have moved away from the general vicinity of a position, or may indicate that they have recently accepted a higher-paying position, or may otherwise indicate their unsuitability as a match.)

If it is determined, based on the candidate's new disclosure, that the candidate is still suitable as a match 511, then the system may proceed to a submission step 6, which may be depicted in FIG. 1. For example, in a submission step 6, the candidate may be added to a curated list of candidates for submission to a hiring manager, or may be submitted to the recruiter for manual approval and addition to a curated list of candidates for submission to a hiring manager, as may be desired.

However, if it is determined, based on the candidate's new disclosure, that they are no longer suitable as a match 511, or if it is determined that there is some uncertainty as to whether the candidate is suitable as a match 511, the system may attempt to resolve the uncertainty, and may determine that it needs additional information and what information it needs 512. If it is determined that the candidate is unsuitable based on what they have disclosed, the system may proceed to a removal step 53. However, if it is unclear whether the candidate is suitable or not, then an auto-response 54 may be generated and may be sent to the candidate requesting more information.

If the response of the candidate is to express disinterest in or reject an opportunity, the system may be configured to take action to remove the candidate from consideration 53. According to an exemplary embodiment, the system may take action to remove the candidate from a campaign for a current job, and may take action to ensure that the candidate is not communicated with again about the current job, or is not communicated with again about the current job for at least a period of time (which may, for example, be preselected or may be selected by the candidate). According to another exemplary embodiment, the candidate may be excluded from other communication (such as communication about other related jobs), or even all communication, for a set, unlimited, or indeterminate period of time (for example, until the candidate re-initiates contact or logs back into a service) not just from communication related to a particular job. However, in some exemplary embodiments, a notification communication may be sent to the candidate indicating that they will be excluded from other communications in the future, if this is desired. The system may then stop the processing for the current candidate 531.

In an exemplary embodiment, the system may be configured to consider the candidate's reasons for rejecting the offer, should any be provided. The system may also be configured to attempt to automatically determine a candidate's reasons for rejecting an offer if no reason is provided. In some embodiments, the candidate's reasons for rejecting the offer may be provided to the recruiter or the hiring manager (which may allow for improvement of the recruitment process, the job description, or any other areas that may be improved). In an exemplary embodiment, the candidate may not be contacted for a period of time that is based on the rejection reasons, or may be derived from the rejection or rejection reasons by an internal algorithm. For example, if the candidate rejects the opportunity based on “too many communications” or “too many irrelevant communications,” the period of time in which the candidate may not be contacted may be lower and may be imposed merely so that the candidate is not harassed by a high volume of communications, whereas if the candidate rejects the opportunity based on no longer being interested in employment in a certain field, the candidate may not be contacted about opportunities in that field for an indefinite period of time. The candidate may also be excluded from being contacted about specific types of offers; for example, according to an exemplary embodiment, the candidate may be marked for exclusion from particular industry segments (whether for a period of time or permanently), may be marked for exclusion from specific job titles or job descriptions, or may be marked for exclusion from any other type of offer based on any other criteria.

Finally, if the response of the candidate is to ask a question about the offer, or to request more information about the offer or anything related to the offer, the system may be configured to execute a question processing step 52. In the question processing step 52, the system may determine whether a question can be answered by a set of pre-programmed responses, and if so provide one of the pre-programmed responses. In an exemplary embodiment, pre-programmed responses may be dynamic rather than static; for example, according to an exemplary embodiment of a question processing step 52, a pre-programmed response may be initially selected having incomplete or placeholder data, and may be customized based on reading information that has been provided as part of a job description or as part of a candidate profile.

If the question cannot be answered by a set of pre-programmed responses, in an exemplary embodiment, the system may determine whether the question can be answered by an AI chat bot. In an exemplary embodiment, an AI bot may be used in addition to the canned question and response sequences of the pre-programmed responses in order to mimic the experience of a human dialogue with the candidate. This may be used for a variety of ends; for example, according to an exemplary embodiment, a conversational AI bot may be used in order to correct the candidate's misconceptions and provide arguments intended to change the candidate's mind if it appears the candidate is considering rejecting an offer for a particular position, or even if the candidate has already rejected an offer for a particular position but appears to have done so (or even potentially may have done so) based on a misconception or misunderstanding. In an exemplary embodiment, a conversational AI bot may be provided that includes some degree of learning behavior, such that the AI bot can be self-teaching over the course of a communications campaign with a particular candidate or over the course of many communications campaigns with many different candidates.

If neither the pre-programmed responses nor the AI chat bot is able to resolve a question of the candidate, then, according to an exemplary embodiment, the system may take other action. For example, according to an exemplary embodiment, the system may be configured to evaluate the question 521, provide an automatic response to the candidate 54 if one can be provided, and notify the recruiter if an automatic response cannot be provided and a manual response is necessary for a candidate inquiry 55. The recruiter may then provide a manual response 56. In some exemplary embodiments, the AI BOT may also be configured to solicit a manual response 56 from a recruiter or transfer communications to the recruiter (for example transferring a call to the recruiter) whenever an intent is not recognized or whenever some specific intent is recognized. For example, if the candidate is recognized as being frustrated with the AI BOT program, and loudly asks “Am I talking to a ROBOT?? ! !,” the AI BOT may automatically transfer the call to a recruiter, and may, for example, indicate this to the candidate (such as by stating “I'm sorry, let me transfer you to my supervisor”). The conversation can then be passed back to the AI BOT whenever desired.

In an exemplary embodiment, the system may include a common question and answer database. According to the exemplary embodiment, when a candidate asks a question that exists in the common question and answer database, or requests information that can be found in the form of an answer in the common question and answer database, the system may be configured to answer the question automatically. According to an exemplary embodiment, the system may be configured to automatically maintain and update this common question and answer database; for example, according to an exemplary embodiment, the system may include a self-teaching algorithm (such as a machine learning algorithm or AI) in order to improve the quality of the automated responses and expand the list of common questions and answers stored in the common question and answer database.

According to an exemplary embodiment, a self-teaching algorithm, such as an AI program, may go beyond improving the quality of automated responses, and may, if desired, proactively ask questions to one or more candidates. For example, according to an exemplary embodiment, the system may be configured to ask about the candidate's experience, desire for a job change, interest in the position, or the like, such as may be desired. In an exemplary embodiment, this behavior may be performed as part of an automatic response step 54; for example, according to an exemplary embodiment, an AI bot or other self-teaching algorithm may be used to not only send automatic responses to candidates, but may also be used to proactively ask questions to candidates and confirm any candidate information that needs to be confirmed, such as may be desired. In an exemplary embodiment, the AI program may determine questions to ask to the candidate based on reading and interpreting the candidate profile, and may be configured to automatically submit these questions to the candidate. In some exemplary embodiments, this task may be performed completely automatically such that a reviewer is not needed for any step of the process; in other exemplary embodiments, it may instead be desired to submit one or more of the questions to a reviewer, such as a recruiter or hiring manager, for review before they are submitted. This may ensure that the role of the recruiter can be minimized after a candidate is sourced, as the recruiter will not need to devote any effort (or will at the very least need to devote substantially less effort) to asking questions, confirming information, and updating the database.

In an exemplary embodiment, a self-teaching algorithm, such as AI software, may be configured to look up any data that may be on file for a particular candidate or which otherwise may be available for a particular candidate. For example, according to an exemplary embodiment, an AI may be configured to look up a social media profile of a candidate in order to confirm details provided by the candidate, or in order to better craft specific questions about the candidate's experience.

For example, according to an exemplary embodiment, the self-teaching algorithm may read the work history of the candidate, and may determine that the candidate, Venkat, has worked with Jenkins-based automation servers at a previous place of work, Cerner Corporation. The self-teaching algorithm may then generate a question such as, “Venkat—I see that you have worked with Jenkins deployment automation at Cerner. How many years did you work with Jenkins? And can you tell me a bit more about your experience with it?”

In some exemplary embodiments, the self-teaching algorithm may be configured to make inferences based on available information, or to seek out information that may be useful to develop other questions. For example, in an exemplary embodiment, the work history of the candidate may show previous work at Cerner, and the candidate may state that they have experience with Jenkins. The self-teaching algorithm may then generate a question such as “Venkat—I see that you have experience with Jenkins deployment information. Was that at Cerner?” and may then ask the above question when it is confirmed that the candidate did gain this experience at Cerner.

In an exemplary embodiment, the self-teaching algorithm may be configured to ask a question multiple times if it does not receive a response. The self-teaching algorithm may alternatively be configured to inquire about another skill or otherwise move onto the next question if it does not receive a response; in some exemplary embodiments, it may be configured to move on immediately, may be configured to ask the question a set number of times before moving on, or otherwise may be configured as desired.

When the self-teaching algorithm receives a response, it may be configured to automatically update a candidate profile record. The self-teaching algorithm may further be configured to reevaluate the candidate, for example periodically or after each response; in an exemplary embodiment, based on the candidate's responses to questions, the self-teaching algorithm may be configured to rej ect the candidate and opt the candidate out of the campaign, and may further be configured to inform the candidate of this. For example, in an exemplary embodiment, a self-teaching algorithm may be configured to inform the candidate that the experience they have does not align with the job, that the recruiter's files have been updated based on the candidate's responses, and that the recruiter will reach out when they identify another job that matches the skills or experience of the candidate or aligns with the answers that the candidate has provided to the questions.

In some exemplary embodiments, the system may be configured to continue a conversation indefinitely or ensure that the conversation persists indefinitely, in order to ensure that all questions asked by the candidate can be processed 52 and can be processed accurately and in the context of other questions asked by the candidate. In some other exemplary embodiments, a set period of time for which the system may persist a conversation may be defined, after which the conversation may be terminated or may be terminated if not refreshed within a set period. In some exemplary embodiments, the behavior of the system when electing whether or not to maintain a conversation and for how long may be defined by or may affect the follow-up rule 411 of step 4 or a similar rule.

For example, according to one exemplary embodiment, conversation dialogue with a candidate may be persisted to unlimited levels, and the system may make use of a framework that allows the context of the conversation to be kept indefinitely; this may be done by, for example, grouping any and all communications with a particular candidate as one conversation having a particular ConversationID, with each separate avenue of communication with the candidate that has been used so far defining a separate thread. The system may further be configured to store intent information and entity information for each of the conversations, and in some exemplary embodiments for each separate thread.

For example, according to an exemplary embodiment, the system may engage in an exchange similar to the following, which may be done by email or through any other method of communication, or set of methods of communication such as email and SMS. In a first communication, a candidate may send an email to an AI BOT stating that “I am interested in this opportunity, but I am concerned about the commute. Is there a chance to work remote or even partially remote? (Message Sent Friday 5:02 PM).” In a second communication, the AI BOT may respond to the candidate that “There is an option for working remote for a few days a week after an initial training period of a month or two. (Message sent Friday 5:05 PM).” In a third communication, the candidate may send another email to the AI BOT inquiring “What's the salary range for the position? (Monday 10:04 AM).”

According to an exemplary embodiment, after this third communication is sent, the system may take into account the previous communications that have been received from and sent to the candidate in question in order to formulate a reply. This means that, for example, the AI BOT will retain the knowledge that the candidate wants to work remote at least partially, despite the fact that it took a reasonably long time for the candidate to ask another question to the AI BOT via email. This is in contrast to current chatbot frameworks that may be in use in the market, which may typically cause a conversation session to expire after a period of time, often around an hour but sometimes as little as five minutes.

According to an exemplary embodiment wherein the AI BOT is configured to persist the conversation for an indefinite period of time until completed, the AI BOT may include further logic to determine when a given conversation is over. This may ensure that every conversation ever initiated is not needlessly persisted indefinitely. For example, an AI BOT may be configured to terminate a conversation after a number of definitive “no” responses or a request from the candidate not to be contacted again.

In an exemplary embodiment, the self-teaching algorithm may be configured to ask about inconsistencies or apparent inconsistencies in information that has been provided by the candidate, or about inconsistencies or apparent inconsistencies between information that has been provided by the candidate and the job description. For example, according to an exemplary embodiment, a particular candidate may apply for a job having a requirement of a bachelor's degree in Computer Science, or an equivalent thereof. The candidate may supply a résumé without any completed higher education. This may prompt a conversation similar to the following:

AI BOT: “This job requires a Bachelors in Computer Science. I did not see any education in your résumé. I also looked at your LINKEDIN Profile and did not see education listed. Do you have a bachelors' degree?” CANDIDATE: “I am in the process of getting a degree from DeVry. Will that be acceptable?” AI BOT: “That's a great question. I will check with the hiring manager and get back to you. In the mean time I'd like to ask you a few questions about your experience.”

In an exemplary embodiment, a self-teaching algorithm may be configured to ask questions about subject matter other than skills, experience, and related matters. For example, according to an exemplary embodiment, the candidate's willingness to relocate for a position may be a key factor in hiring for the position. The self-teaching algorithm may thus be configured to inquire about a candidate's willingness to move, in order to try to develop the candidate's reasons for moving in more detail. For example, according to an exemplary embodiment, an AI BOT may proactively ask a candidate “Can you tell me a bit more about why you are looking to make a move now?” The AI BOT may then develop one or more responses based on the candidate's response.

In an exemplary embodiment, the self-teaching algorithm may make use of a dialogue approach in order to ensure that the candidate has properly understood aspects of the position or has properly communicated their own information. For example, in an exemplary embodiment, a candidate may supply a résumé to a position showing that they live approximately 60 miles from a job location. Under such circumstances, according to an exemplary embodiment, the self-teaching algorithm may proactively ask the candidate about the candidate's current address. Then, if the candidate confirms that their current address is the current address they provided on their résumé and they live 60 miles from the job location, the self-teaching algorithm may be configured to confirm that the candidate understands that the job location is reasonably far away, and may in some circumstances inquire about whether the candidate has any intention of relocating or any willingness to relocate for the position. This may prompt a conversation similar to the following:

AI BOT: “Are you still residing at 101 Main Street, Pittsburgh?” CANDIDATE: “Yes.” AI BOT: “Got it. It looks like your commute would be 60 miles and Google Maps says it's about 90 minutes during rush hours. Does that work for you?” CANDIDATE: “I plan to relocate if hired.” AI BOT: “Got it.”

In an exemplary embodiment, a self-teaching algorithm may also be utilized in order to investigate or explore any specific job requirements that the candidate has articulated. For example, according to an exemplary embodiment, a candidate may be asked to provide a desired proximity or a desired salary range for a position at the same time as the candidate is asked to submit their résumé. In the event that a close match between the candidate and a particular position is found, or in the event that the closest matches between the candidate and a position are positions that fall closely outside of the candidate's requirements, the candidate may be asked about the close match or the closest available matches.

For example, according to an exemplary embodiment, a candidate may be asked about a desired salary range and may provide a desired salary of at least $80,000 per year, or a desired salary range of at least $80-85,000. However, a close match may be found between the candidate and a position that pays slightly less than this minimum salary range but has other benefits; for example, the position may have a good health plan or may allow the candidate to save on travel costs by working from home. This may prompt a conversation similar to the following:

AI BOT: “My file says you are looking to make $80-85 k per year. Are you open to a position that's 100% work from home that pays $70-$75 k?” CANDIDATE: “No, I really need to be at $80-$85 k.” AI BOT: “I will check with the hiring manager to see if we can submit you above the range. In the meantime, I'd like to ask you a few questions about your experience.”

Once the candidate has had a question or request for information answered, or has submitted requested information to the AI BOT, it may be understood that the candidate may have additional questions or requests for information, and may be understood that the candidate may have to provide an acceptance or rejection. The system may thus restart a response step 5, and may evaluate the next candidate response.

In some exemplary embodiments, the response step 5 may be configured or may be configurable to run multiple times on the same candidate communication. For example, it may be envisioned that a candidate may provide an email response in which they express interest in an opportunity, but ask a number of questions about the company in preparation for an interview. The system may be configured to both finalize the candidate 51 and execute one or more question processing steps 52.

In some exemplary embodiments, the response step 5 may be configured to prioritize one type of responsive action over another in some cases. For example, in some exemplary embodiments, the candidate may reject an opportunity and may provide an explanation for why they did so that is based on a misconception or based on incorrect information. The system may execute a question processing step 52 and may give the candidate the opportunity to reconsider their rejection before removing the candidate 53.

Finally, when any type of candidate response is received, and before, after, or during any action—including the step of finalizing a candidate 51, the step of question processing 52, or the step of removing a candidate 53—the system may be configured to automatically evaluate any information provided by the candidate in their response. The system may then be configured to determine whether the information provided by the candidate should be added to one or more records of the candidate, and may then be configured to update the candidate record or records within the system as appropriate.

Further, during a response step 5, a candidate may be provided with the opportunity to update one or more details not directly related to finalization, such as, for example, their contact information or preferred contact information, or any other relevant information, as may be desired.

In an exemplary embodiment, at any stage of the process, a candidate may be requested, by the system, to provide information in a form that may be more easily parsed by the system. For example, according to an exemplary embodiment, a candidate may be provided with a web form that allows them the option to expand upon or clarify their experience in one or more skills that might be required for a position. This list of skills may be provided at the same time that the job description is input into the system, which may be done manually (e.g. through the provision of a skills list, separate from the job description, by the hiring company) or may be done through parsing of the job description by the system. In an exemplary embodiment, the candidate may be specifically requested to identify the number of years of experience that they have associated with each of the skills in the skills list, the most recent year the skill was used, the positions that the skill was used at, a description of how the skill was used, and/or any other information that may be applicable; alternatively, such identifications may be optional.

Additionally, in some exemplary embodiments, the candidate may be requested to provide (or may optionally be requested to provide) answers to additional qualifying or screening questions, as previously discussed. Such questions may be, for example, clarification questions about the candidate's experience, or may be any other appropriate questions, as may be desired. In some embodiments, these questions may be provided as a part of the process of vetting the candidate for the position, and the candidate may be disqualified from applying for the position based on the answers that the candidate provides, or based on a lack of response or lack of appropriate response from the candidate.

In a next step, which may be a submission step 6 (as shown in FIG. 1), the results of a recruitment campaign may be assembled. According to an exemplary embodiment, once one or more completed and vetted applications have been generated by the system, the completed and vetted applications may be submitted to the recruiter and/or to the hiring manager. In an exemplary embodiment, in a submission step, the completed and vetted applications may be communicated to the recruiter by any of the communication channels previously described, the recruiter may have the option to review the completed and vetted applications and make any necessary changes or take any other necessary steps (such as, for example, requesting more information from the candidate), and the recruiter may then submit the completed and vetted applications to the hiring manager. In some other exemplary embodiments, the AI BOT program may automatically submit the completed applications to the hiring manager, along with any revisions that may be necessary; for example, according to an exemplary embodiment, an AI BOT may be configured to submit one or more candidates to the hiring manager, and may also be configured to reformat the candidate's résumé so that the aesthetic structure of the résumé or the language used in the résumé (or any other attributes) are more appealing to the hiring manager or more consistent with guidelines or rules set forth by the hiring manager. The AI BOT may be configured to perform these automated activities or any other automated activities, such as may be desired.

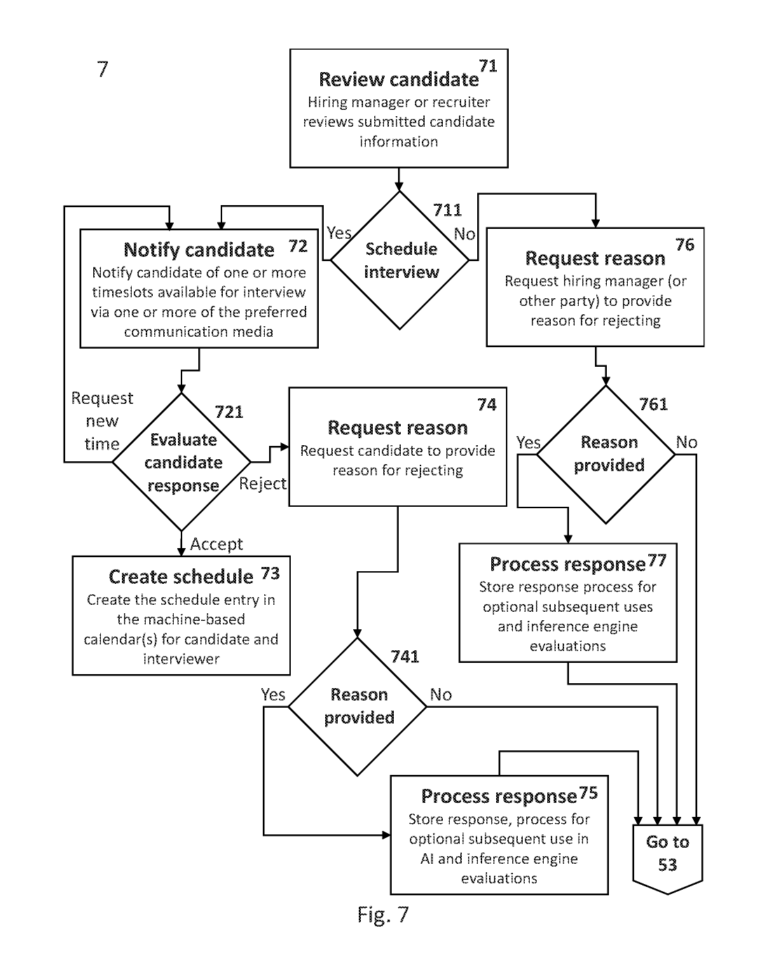

The hiring manager, or any other appropriate party, may then undertake a review step 7. In a review step, a hiring manager may review the completed and vetted applications and make any necessary changes or take any other necessary steps (such as, for example, requesting more information from the candidate) and may then undertake to schedule an interview with the candidate. In an exemplary embodiment, the hiring manager may confirm or deny that the candidate will receive an interview via any of the channels listed above, such as any of the communication channels that may be used by the candidate to apply for the position. In an exemplary embodiment, the hiring manager may specifically make use of the communication channel that the candidate used initially to apply for the position, and may, for example, place a telephone call if the candidate placed a telephone call initially. This may be shown in more detail in exemplary FIG. 7.

According to an exemplary embodiment, in a first part of a review step 7, once a list of candidates has been submitted to a hiring manager, the hiring manager, or another similarly-situated party such as a recruiter, may review the submitted candidate information 71. In an exemplary embodiment, the steps of the method may be performed by the hiring manager or recruiter and therefore there may be no need for an intermediate review process or a submission process 6. However, in other exemplary embodiments, these may be broken up among different parties, as may be desired.

In a next part of a review step 7, it may be determined whether one or more interviews should be scheduled with the candidate 711. If, based on the review of the hiring manager, recruiter, or other similarly-situated party, the candidate warrants an interview, one or more interviews may be arranged with the candidate in order to further evaluate the candidate. According to an exemplary embodiment, if the candidate does not warrant an interview, the candidate may be removed in a removal step 53. However, if the candidate is determined to warrant an interview, one or more schedulable times for an interview may be selected 711.

According to an exemplary embodiment, optionally, if a hiring manager, recruiter, or other similarly-situated party performing manual review determines that the candidate does not warrant an interview and is to be removed in a removal step 53, the system may request a reason 76 as to why the candidate does not warrant an interview or as to what other reasoning the hiring manager or other party used in order to determine that the candidate should be rej ected. If the hiring manager or other party provides a reason 761 after one is requested 76, the reason that they used may be stored and processed 77 in order to improve the functionality of the automated system. For example, this response 77 may be used in subsequent evaluations performed by the AI or the inference engine. This response 77 may also trigger a new matching and/or sourcing step, if such is desired.

In some exemplary embodiments, the hiring manager may further clarify the job description before the new matching and sourcing step is triggered, or the new matching and sourcing step may otherwise be based on new information that has been provided by the hiring manager. For example, according to an exemplary embodiment, a hiring manager may reject a submitted candidate and provide the reason of “this candidate does not have enough inside sales experience,” or “I am looking for someone with AWS cloud migration experience,” or “candidates need to have 5 years of controls engineering using Rockwell,” when this information was not mentioned in the job description. This feedback information may be incorporated as new skill requirements when the matching and sourcing step is run again.

Once the response has been processed 77, or if no response is provided by the hiring manager or other party in response to the request 761 (for example, after a set amount of time has passed after an initial request to provide a reason 76 is provided to the hiring manager) the candidate may be removed in a removal step 53. Alternatively, in an exemplary embodiment, the candidate may be removed immediately 53 and the hiring manager or other such party may have a certain time window in which they can provide explanation for this removal.

The candidate may then be notified of one or more timeslots at which an interview may take place 72, via one or more of the preferred communication media that has been used to contact the candidate or via one or more other forms of media. In an exemplary embodiment, a candidate may have more than one option for how the interview can be conducted, and may have different timeslots open for each; for example, the candidate may have the option to interview at different offices which each have different schedules and different interview times, or the candidate may have the option to interview in person in a first set of timeslots or by phone or video chat in a second set of timeslots. In an exemplary embodiment, these timeslots may be exclusive to the candidate, or may be shared among other candidates; according to an exemplary embodiment wherein these timeslots are shared among other candidates (and are, for example, first-come-first-served), the candidate may be notified if some or all of the listed timeslots have been filled by other candidates.

A response may then be solicited from the candidate, and the candidate's response 721 may be evaluated. A candidate's response may be, for example, an acceptance of the offer to interview at a particular time, a rejection of the offer to interview at a particular time (which may include, for example, an extended period of nonresponse, which may be treated as a rejection), or a request for a new time from the candidate.

According to an exemplary embodiment, when a candidate has accepted an offer to perform an interview at a particular time, a schedule may be created 73. In an exemplary embodiment, a schedule entry may be created in a machine-based calendar or multiple machine-based calendars (such as a MICROSOFT OUTLOOK calendar) for either or both of the candidate and the interviewer. For example, according to an exemplary embodiment, a candidate may be emailed a calendar entry that may be integrated, from their email inbox, into a calendar.

According to an exemplary embodiment, a candidate may request a new time for an interview. According to an exemplary embodiment, this may result in a repeat of one or more of the previous steps. For example, one or more timeslots previously reserved to another candidate may be freed in a schedule of a hiring manager or recruiter, or one or more timeslots previously reserved to events other than conducting interviews may be freed. The candidate may then be notified about the new timeslots 72 and a response from the candidate may be solicited.

According to an exemplary embodiment, a candidate may reject an offer to interview at a particular time. According to an exemplary embodiment, the candidate may only be provided with the option to do this after the candidate has already indicated a level of interest in the opportunity; as such, according to an exemplary embodiment, the candidate may be asked why they have declined the opportunity to interview 74. In an exemplary embodiment, a request for a reason why the candidate has declined an interview may include one or more preselected options (such as the candidate having received a more promising interview or offer elsewhere, or the candidate having changed personal circumstances resulting in them no longer being able to pursues that position) or may include an open-ended response option.

In an exemplary embodiment, when the candidate has provided a response 741, the response may be stored and may be processed 75 in order to improve the process. The response of the candidate may optionally be used by an AI or by an inference engine in order to improve future evaluations of candidates. For example, if many candidates are declining interviews because there is too much time taken between the first steps and the last steps of the method, the responses of the candidates may be stored and may be used to show that the speed of the process needs to be improved. In either case, when the candidate has or has not provided a response, the candidate may be removed in a removal step 53.

Candidates may also be requested to provide scheduling information. In an exemplary embodiment, it may be desirable to try to schedule an interview with the candidate immediately after the candidate has been identified as acceptable and approved by a hiring manager. In such an embodiment, the candidate may be requested to provide a date and time, a set of dates and times, or a timeframe window in which they can be available for an interview. In some embodiments, candidates may be solicited for scheduling information for different types of interviews, such as, for example, in-person interviews, video-chat interviews, or phone interviews or interviewed conducted by SMS/Text or some other type of platform, each of which the candidate may have different levels of availability for. In some exemplary embodiments, the candidate may be given lower priority or may be disqualified from applying for the position based on their availability for an interview; for example, if the candidate would not be able to attend an in-person interview for a long period of time, they may not be considered for a position that demands immediate consideration of the candidates.

According to an exemplary embodiment, interview scheduling information, as well as any other information that may have to do with setting dates and times for events, may be handled by a web-based or machine-based calendar system. In an exemplary embodiment, any party involved in the process, such as the candidate, the recruiter, the hiring manager, a department manager involved with the hiring process, or any other party, may be able to propose, accept, reject, and/or modify entries in the calendar system. Such parties may also be able to directly create, edit, and delete events in the calendar system, may be able to invite participants, may be able to specify participation requirements, or may have any other functionality available to them, as desired. Alternatively, in some embodiments, some parties may have freer access and other parties may have more restricted access to the calendar system; for example, in an exemplary embodiment, a candidate may be able to propose a date and time for an event, but only the hiring manager may be able to approve a proposed date and time for the event. In an exemplary embodiment, the parties that have access to the calendar system may have such functionality available to them throughout the hiring process, or only at specific times during the hiring process, as desired.

As discussed briefly, a system may be configured to handle and respond to a number of types of response, over a number of different communication channels, which may be provided by a candidate. In some embodiments, candidates may be able to apply for a position or schedule or accept an interview using any communication method over any acceptable communication channel. This may include, for example, calling the recruiter, sending a message to the recruiter requesting a call back at a particular time, visiting a web form either directly (e.g. by searching) or by a provided hyperlink, replying to an email or sending an email to a recruiter or to an email address of the system, replying to a posting on a job board, replying using SMS or another form of text messaging, or any other acceptable communication method, as may be desired.

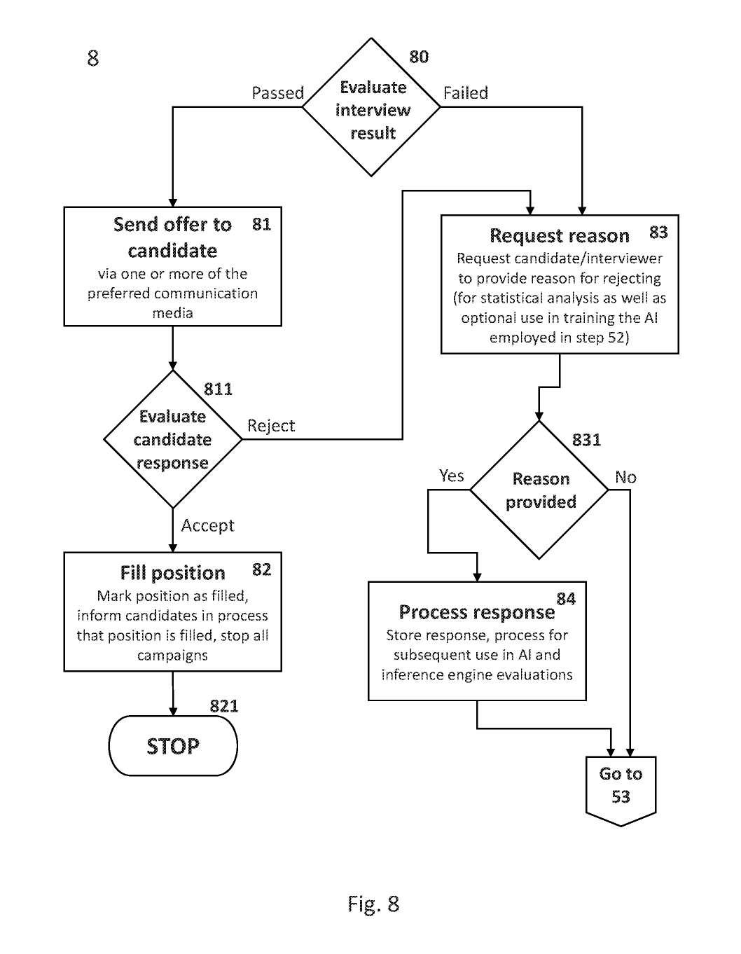

In an exemplary embodiment, once one or more interviews have been completed, an offer step 8 may be performed. Such a step may be shown in more detail in exemplary FIG. 8.

According to an exemplary embodiment, in a first part of an offer step 8, an interview result may be evaluated 80. The candidate may be considered to have passed or have failed the interview, or may be considered to be borderline and an additional interview may be conducted.

If the candidate is considered to have failed the job interview, this information may be provided to the system, and the system may request a reason 83 from the interviewer or other reviewer as to why the candidate failed or was otherwise rejected. In some exemplary embodiments, this may be used for the purpose of conducting statistical analysis on the one or more candidates for the position, on one or more candidates considered to have been improperly selected by the system, or any other statistical analysis that may be considered to be useful. In some exemplary embodiments, the reasons 83 provided by the interviewer may be used to further train the AI employed in previous steps, such as step 52.

Once a reason has been provided, or if a reason is provided 831, the response may be stored and may be processed for use in subsequent AI and/or inference engine evaluations 84. The system may then proceed to a step of removing the candidate 53.

If the candidate is considered to have passed the job interview, this information may be provided to the system, and the system may be configured to automatically generate and send an offer to the candidate via one or more of the preferred communication media 81. In an exemplary embodiment, the response of the candidate may then be evaluated 811. In an exemplary embodiment, this response may be considered to be an acceptance, a rejection, or a counteroffer.

In an exemplary embodiment wherein the candidate accepts the job offer, the system may mark the position as having been filled 82. In an exemplary embodiment, once the position has been filled, the system, or the hiring manager or any other party, may then notify the other candidates that the position has been filled and confirmed. The system may then stop all campaigns for the position and stop the hiring process for the position 821.

In an exemplary embodiment wherein the candidate presents a counteroffer, in an exemplary embodiment, the system may direct the counteroffer to the hiring manager. In some exemplary embodiments, a counteroffer may be handled similarly to an acceptance or similarly to a rejection. In one exemplary embodiment, the position may preliminarily be marked as filled while the negotiation is being conducted; in another exemplary embodiment, the system may solicit other acceptable candidates in order to attempt to find a candidate that accepts the offer without modification. In still other exemplary embodiments, anything other than an acceptance may be counted as a rejection.

In an exemplary embodiment wherein the candidate rejects the job offer, a reason may be requested from the candidate as to why the job offer was rejected 83. In an exemplary embodiment, such a reason may be used to better train an AI used in previous steps. In an alternative exemplary embodiment, such a reason may be evaluated by a hiring manager and read in order to see if the candidate had intended to provide a counteroffer or otherwise expressed continued interest in the position. The system may also be configured to evaluate whether the candidate had intended to provide a counteroffer or otherwise expressed continued interest in the position, and may be configured to contact a hiring manager if it discovers either.

Once a response has been solicited 83, if the reason is provided 831, it may be processed 84. The system may then proceed back to a step of removing the candidate 53.

In some exemplary embodiments, it may also be desired to have the AI BOT complete all or part of an interview procedure, in addition to performing a review step 7 before an interview and evaluating an interview result in an offer step such as is shown in FIG. 8. For example, in an exemplary embodiment, an AI BOT may complete a first part of an interview procedure or a first interview, which may include, for example, basic question-and-answer portions for the candidate (for example, the candidate may be asked about a time they demonstrated a particular skill) and a human recruiter may complete the second part of an interview procedure or a second interview, either alongside or instead of the AI BOT.

For example, according to an exemplary embodiment, a hiring manager may start by selecting one or more submitted candidates that it may be desired to have interviewed by the AI BOT. In some exemplary embodiments, this may be done by another party, for example by a recruiter, before results are delivered to the hiring manager, in order to refine the results that are provided to the hiring manager, or in order to provide more detail about the candidates to the hiring manager and allow a more informed decision to be made. In some exemplary embodiments, this may be done to any selection of candidates or to all candidates; for example, in an exemplary embodiment, all candidates may have to go through a pre-screening interview with an AI BOT or may have to go through a first interview with an AI BOT in order to go forward.

In an exemplary embodiment, an AI BOT may be provided for an interview at any time when the candidates is available to do the interview, and no scheduling may be required. In some exemplary embodiments, the candidate may be informed that they have been selected to proceed to a next step wherein they can complete an interview with the AI BOT in order to determine if they can advance further, and may be provided with a link to start the interview at any time. In other exemplary embodiments, the candidate may be requested to interview at a specific time (such as at a mutually agreeable time worked out with the candidate beforehand), or at one of a set of specific times, in order to promote engagement with the candidate by making the candidate feel like they are interviewing with a human, or in order to allow a human recruiter to take over the interview should they desired to do so. In some exemplary embodiments, it may be desired to stagger the AI BOT interviews with candidates, such that, of hundreds of candidates receiving interviews, only a fraction of the candidates are engaging in interviews at any one time; in some exemplary embodiments, the AI BOT may be configured to simultaneously interview all of the candidates (or a sizeable fraction of the candidates such as hundreds of candidates) at the same time.

In some exemplary embodiments, the candidate may be able to break up the interview across multiple sessions, such that the candidate can stop the interview process and continue the interview process later in the day, or even the next day. In some exemplary embodiments, the candidate may not be able to complete the interview in multiple sessions, and it may instead be required for the candidate to complete the interview in a single session. In some exemplary embodiments, the interview may expire after a certain time period has passed; for example, according to one exemplary embodiment, the interview may be available for a certain number of hours or for a certain number of days after the candidate has clicked the link to begin the interview, after which the interview may terminate. In some exemplary embodiments, the candidate may then be able to restart a new interview session from the beginning, if it is desired to permit them to do so. In some exemplary embodiments, the interview availability may terminate at a certain specific time or deadline for all candidates. In some exemplary embodiments, there may be different requirements for different interviews, or for different interview questions; for example, according to an exemplary embodiment, a time limit may be provided for one or more questions, which may be set for all questions, for a set of questions, or for each specific question. For example, in an exemplary embodiment, a candidate may be asked general questions in an interview and may have unlimited time (or a significant amount of time) to answer those general questions, but may also be asked to solve one or more problems and may have a limited amount of time to provide their solution, in order to ensure that the candidate can solve problems quickly.

In some exemplary embodiments, interviews may be provided though any appropriate medium. For example, according to some exemplary embodiments, interviews may be conducted via email, SMS, FACEBOOK MESSENGER, web page text chat, a mobile app, WHATSAPP, telephone, or through any other medium or plurality of media such as may be desired. In some exemplary embodiments, the candidate may be able to choose a medium or may be able to choose from a limited set of communications media, as may be desired. In some exemplary embodiments, certain interview or interview questions may be limited to a certain communications medium; for example, in an exemplary embodiment, the AI BOT may request that the candidate write example code or pseudocode on a whiteboard in response to a prompt, and the candidate may be required to do this via video chat so it can be verified that it is really the candidate that is writing this code. (Alternatively, the candidate may be required to provide these responses via text chat so that the AI BOT can more easily interpret them.) In some exemplary embodiments, the AI BOT may have certain functionality when some communications media are used that may not be used when other communications media are used; for example, according to an exemplary embodiment, when the candidate conducts an interview via video chat, the AI BOT or another AI Engine may look for certain mannerisms or other visual cues of the candidate, and may only look for keywords when the candidate conducts an interview via text. (In some exemplary embodiments, it may be required that the candidate conduct an interview via a certain communications medium in order to enable the functionality, as may be desired.)

According to one exemplary embodiment, the AI BOT may conduct interviews based on a list of interview questions that have been provided by the hiring manager. In some exemplary embodiments, if the AI BOT is not provided with questions or if the AI BOT asks all of its questions without completing the interview, the AI BOT may be configured to select from one or more questions in a repository, or may be configured to create questions on the fly for the candidate. In some exemplary embodiments, questions may be created based on reading the job description and the candidate's profile, which may include, for example, some or all of the information that has been collected during the recruiting process. In an exemplary embodiment, the AI BOT may access questions in a repository or may otherwise access preset questions that are based on, for example, industry or job title; these may be generated based on, for example, previous interview questions that have been added to the repository after meeting certain criteria (such as, for example, being asked in a certain number of previous interviews) or may be generated based on other compiled data, such as data that might be found on the web.

In some exemplary embodiments, interview questions may be asked one at a time until a satisfactory answer is provided by the candidate. In some exemplary embodiments, if the candidate does not satisfactorily answer the question, the AI BOT may ask the question in a different way, or the question may be skipped and asked again at a later point, such as may be desired.

In some exemplary embodiments, each question to be asked, or some of the questions to be asked, may be based on a previously-asked question or may be based on a received answer. For example, according to an exemplary embodiment, the AI BOT might ask a follow up question or change the questions asked based on a response from a previous question, if desired. In another exemplary embodiment, the AI BOT may decide to omit one or more of the questions, or may otherwise reduce the number of questions to be asked. In one example, this may be done if it is determined early on in the interview that a candidate is not a good fit and it is desired to end the interview early. In another example, this may be done if the AI BOT determines that the candidate is losing interest in the position or is otherwise disinterested; in such a case, according to an exemplary embodiment, the AI BOT may skip one or more questions or may ask additional questions relating to the interest level of the candidate. The AI BOT may also change the order of questions based on the response of a candidate, such as may be desired.

According to an exemplary embodiment, the AI BOT may solicit additional information from the candidate in the interview. For example, according to an exemplary embodiment, the AI BOT might ask the candidate to send samples of work, for example source code, a design portfolio, or the like. The AI BOT may also solicit references from the candidate, such as may be desired. In some exemplary embodiments, at the end of the interview, the full transcript of the interview may be made available to the recruiter or hiring manager for review; in an exemplary embodiment, the additional information may be sent along with an interview transcript to the hiring manager.

According to an exemplary embodiment, the AI BOT may be configured to respond to questions asked by the candidate in the interview in the event that the candidate asks questions in the interview. In an exemplary embodiment, the AI BOT may answer the questions and may make use of a machine learning algorithm in order to improve the responses provided to successive candidates. In another exemplary embodiment, one or more questions may be provided to a human recruiter to answer, such as, for example, if the AI BOT is not able to answer the question.

In an exemplary embodiment, the AI BOT may go beyond asking the candidate to solve a problem with pseudocode or the like, and may ask the candidate to take a formal coding test or assessment. In some exemplary embodiments, the test or assessment may be scheduled ahead of time based on the availability of the candidate, if advance scheduling is required.

According to an exemplary embodiment, once the interview has been completed, a transcript of the interview may be prepared. In some exemplary embodiments, the transcript may be provided to a hiring manager and the hiring manager may make the decision as to whether or not to bring in the candidate for a second interview, such as, for example, an in-person interview. In some exemplary embodiments, the transcript of the interview may be fed into an AI engine for analysis instead of or in addition to providing it to the hiring manager. In some exemplary embodiments, the AI Engine may then determine whether the candidate is to be brought in for a second round of interviews. For example, according to an exemplary embodiment, the AI Engine may look at other candidates that have been hired or interviewed for a similar role at this company, and/or may look at other candidates that have been hired or have been interviewed for similar roles at other companies, and may compare the transcript to the performance of those other candidates. In some exemplary embodiments, this comparison may use, for example, text analytics, sentiment analysis, or a comparison of the data point matrix of the interview transcript with the data point matrix of candidates that have been hired for a similar role. In such exemplary embodiments, or in other exemplary embodiments, a data point matrix may be created for all interview transcripts.

In some exemplary embodiments, it may be desired for a hiring manager, or an AI BOT, to ask one or more clarification questions without necessarily committing to an interview with the candidate. In such exemplary embodiments, the system may function as a messaging platform and deliver the question to the candidate. For example, in some exemplary embodiments, a message such as “Hi [Candidate Name], We have an opening at our company that we feel you might be a great fit for. Below you will find the job description,” may be provided to a candidate.

In some exemplary embodiments, the system may be configured to choose a channel that it has determined is most likely to receive a fast response; for example, in an exemplary embodiment, a communications channel may be chosen based on past communications with a candidate or aspects thereof (such as past candidate engagement and preferences), may choose a communications channel based on the candidate's demographic or other information, or may choose a communications channel based on the candidate being available or unavailable using a certain service. (For example, if a candidate is signed in to SKYPE, they may be contacted via SKYPE, if desired.) When a response is received, it may be forwarded to the hiring manager; in some exemplary embodiments, the response may be delivered to the hiring manager by a web interface or by any other communication channel, which may in some exemplary embodiments be chosen or customized by the hiring manager. The use of the system as a messaging platform may allow the hiring manager's name and contact information or the candidate's name and contact information to be obfuscated, if desired.

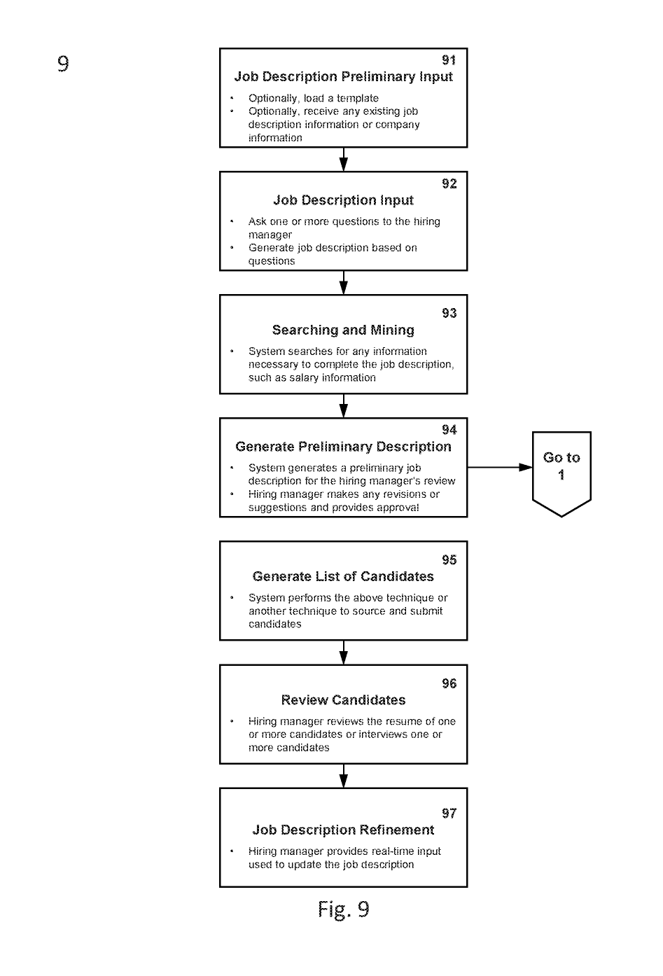

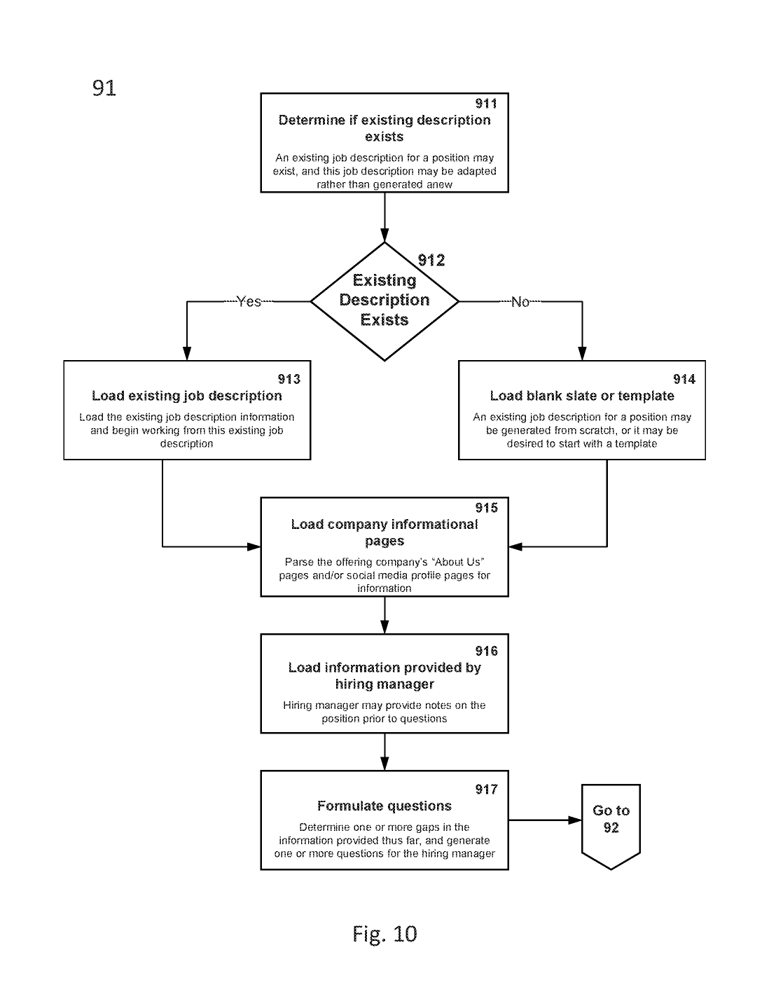

Turning now to exemplary FIG. 9, FIG. 9 displays an exemplary embodiment of a flowchart depicting a method of creating a job description 9. Such a method may be used in order to quickly develop a job description that accurately conveys the responsibilities of a position or the skills needed for the position, and which may improve on an old job description template that is not effective, that is outdated, that is an overly-generic template job description, or which is otherwise flawed. In some exemplary embodiments, the method may include the steps of receiving preliminary input information for a job description 91 (which may be shown in more detail in exemplary FIG. 10), receiving job description input from a hiring manager through a question-and-answer process 92, performing searching and mining for any necessary or desired information such as salary information 93, generating a preliminary job description 94 for the hiring manager's approval, performing a sourcing process (such as the sourcing process shown in FIG. 1 or another appropriate sourcing process), generating a list of candidates 95 from the sourcing process, reviewing the candidates 96 provided by the sourcing process, and providing any refinements to the job description that may be necessary 97.

According to an exemplary embodiment, in a first step, one or more preliminary inputs may optionally be provided 91, if any are available. For example, if an existing job description exists and it is desired to improve the existing job description rather than replace it entirely, the existing job description may be initially imported. In another example, it may be desired to start with a template for the position or for a similar position, and further refine the template through the method 9, as may be desired.

According to an exemplary embodiment, a step of receiving preliminary inputs 91 may also include a step of importing any other job description information or company information that may be available. For example, according to an exemplary embodiment, a hiring manager may provide one or more notes about the position that have not yet been developed into a job description, for example based on a meeting with the manager or department head that has a position to be filled. In an exemplary embodiment, a system or component of the system, such as an AI BOT, may also collect description information on its own. For example, in an exemplary embodiment, an AI BOT may be coupled with speech-to-text software and may itself be able to record a meeting that a hiring manager conducts with a departmental manager, such that the AI BOT can record any requirements of the position that are specified by the departmental manager.

In another exemplary embodiment, the AI BOT may also conduct one or more searches about the company performing the hiring, or may otherwise import information about the company, in order to perform a preliminary input step. For example, according to an exemplary embodiment, an AI BOT may parse a company website or specific portions of a company website (such as the “About Us” page of the company website) or may parse one or more social media profiles of the company (such as a company LINKEDIN profile), and may incorporate some or all of this data into the job description in a preliminary input step 91. In some exemplary embodiments, the system may also perform searching of one or more other company webpages or one or more other locales (such as one or more template repositories) in order to retrieve preliminary information to be refined by a question-and-answer step or other job description input 92 from a hiring manager.

In a next step, a job description input step 92 may be performed. In a job description input step 92, one or more questions may be asked to the hiring manager, and the job description may be generated based on the answers provided by the hiring manager.

In a first example, an exemplary embodiment of an AI BOT may be configured to ask about a job location. For example, an AI BOT may begin by asking, “What location is this position for? Please provide me the full address.” The hiring manager may then respond that the position is to be provided at 10 Main St, Anywhere Calif. 90210. The AI BOT may next respond, “Got it. Can this position be worked remotely? If not, is there some flexibility to work from home?” The hiring manager may then respond “No, this requires an onsite presence but we do offer the flexibility to work from home 1 to 2 days per week.” The AI BOT may then draft location information for the job description accordingly.

In some exemplary embodiments, the AI BOT may ask for further details about the location, such as details about the company culture at the location or other similar details. For example, in an exemplary embodiment, an AI BOT may ask, “What are some of the key reasons why someone would be interested in working for your organization [or why someone would be interested in working for your organization at this location]? I want to create a bullet list of top reasons to attract great candidates.” A hiring manager may respond with various reasons, such as, for example, “We are a small team and there's a lot of autonomy, we offer equity, Summer Fridays, and the ability to work on really cool cutting-edge technology!” The AI BOT may then reply with “Wow, I want to work for you :).”

In an exemplary embodiment, an AI BOT may specifically attempt to construct an explicit list of benefits of working at the company that can be provided in the job description, on the grounds that constructing such an explicit list of benefits can increase the response rate of candidates by up to 300%. According to an exemplary embodiment, in addition to soliciting reasons from a hiring manager (or incorporating any reasons that are offered by a hiring manager), a system may be configured to crawl, scrape, and parse company reviews, company social media sites, news articles, or any other sources for positive information. In some exemplary embodiments, an AI BOT may be configured to perform any or all of the crawling, scraping, or parsing that may be required, while in other exemplary embodiments an AI BOT may communicate with another system in order to conduct some or all aspects of the searches. For example, in an exemplary embodiment, an AI BOT may call an API or execute a backend process in order to perform a crawling, scraping, and/or parsing step, and perform the remaining steps itself. For example, according to one exemplary embodiment, after material has been crawled and scraped, an AI BOT may parse a company's employee reviews on GLASSDOOR.COM for positive feedback and may determine one or more benefits from the positive feedback. In another exemplary embodiment, an AI BOT may parse the comments on a company's LINKEDIN profile or the comments that have been shared with the company's TWITTER profile for positive feedback, and may determine one or more benefits from the positive feedback. In another exemplary embodiment, an AI BOT may draw one or more benefits from a company's career site, or from any other accessible website, for ideas. These benefits may then be suggested to the hiring manager for potential selection, if desired. An AI BOT may also be configured to look at other postings, such as job postings by competitors, for benefits, and may determine if these benefits are also offered by the hiring manager's company. These benefits may likewise be suggested to the hiring manager for potential selection.

In another exemplary embodiment, it may be desired to derive benefit information from the employees who work at a company. For example, in an exemplary embodiment, an AI BOT may be configured to reach out to the employees of a company, or to one or more specifically-designated employees of the company such as recipients of “employee of the month” awards, in order to ask these employees why they like working at the company. In some exemplary embodiments, this may be done through any communication channel, such as SLACK, email, text, FACEBOOK MESSENGER, or any other such channel as may be desired. In other exemplary embodiments, an AI BOT may host a poll or may otherwise accept suggestions such as may be desired.

In a second example, an exemplary embodiment of an AI BOT may be configured to ask about what title to use for the position in the job description. In some exemplary embodiments, the job description may be provided on a site on which candidates may search for jobs using job titles, and as such the AI BOT may place some emphasis on securing the correct job title (or a correct job title) in order to secure an appropriate candidate. In an exemplary embodiment, the AI BOT may be configured to provide a list of similar titles, or may otherwise be configured to suggest a better title if one can be found.

For example, an AI BOT may begin an exemplary conversation by asking “What's the title for this position?” The hiring manager may then respond, “Senior Engineer.” The AI BOT may then ask, “What is the technology stack?” The hiring manager may then respond, “.Net, with C# and VB.NET.”

The AI BOT may then provide a list of proposed alternative titles. In some exemplary embodiments, these may be based on a list or “title thesaurus” stored by the AI BOT, which may in some exemplary embodiments be maintained at a local, regional, national, or global level. In other exemplary embodiments, the titles of positions may be compared to the titles of other positions that are being advertised. For example, it may respond, “Based on the data we compiled, a more descriptive job title will increase candidate response. Here are some alternatives. .NET Developer, C# Developer, Microsoft Full Stack Developer. By the way, there are currently 321 Sr. Engineer, 288 .NET Developer, 84 C# Developer and 33 Microsoft Full Stack Developer Openings in your area. (I checked within a 30-mile radius.) If you want me to expand or reduce the mile radius, just let me know!”

The hiring manager may then decide on one or more of these titles to be provided, or may elect to go with some other title, as may be desired. For example, the hiring manager may reply “Great intel! For now, let's go with .NET Developer.” The AI BOT may then reply, “You got it!”

In a third example, the system may ask questions in order to determine what the responsibilities of the position are. For example, an AI BOT may ask, to determine what the candidate will be doing on a day-to-day basis, “What will the candidate be doing on a day to day basis?” The hiring manager may then provide a response, “Enhancing the existing customer relationship management software as well as debugging the existing code base.” In some exemplary embodiments, the AI BOT may then continuously prompt the hiring manager for further information until the hiring manager confirms that all known responsibilities have been listed. For example, the AI BOT may then respond, “Got it, what else?” The hiring manager may then respond, “The candidate will be responsible for deploying and managing the application on AWS Cloud and working closely with the end users to determine what their needs are.” The AI BOT may then respond, “Anything else?” The hiring manager may then respond, “That's pretty much the main responsibilities,” confirming that all known responsibilities have been provided.

In an exemplary embodiment, the AI BOT may then perform a step of analyzing the responsibilities or comparing the listed responsibilities to responsibilities of other jobs in order to identify any other responsibilities that may be listed. For example, a hiring manager may describe a client-focused software developer position based on the responsibilities that distinguish it from other software developer positions in the company, and may for example indicate that the position will work closely with end users in order to determine what their needs are, but may forget to provide the baseline responsibilities for a software developer position; the AI BOT may determine that these are likely to be missing and prompt the hiring manager to provide them. In another example, an AI BOT may compare the position to other jobs offered by other companies, such as may be provided in the following example conversation. For example, the AI BOT may inform the hiring manager, “Here's some other responsibilities that I found for similar jobs. 1) Data Modeling 2) Developing APIs 3) Help with requirements gathering. Do you want to add any of these to the job description?” The hiring manager may then respond, “Yes, let's add Data Modeling.” The AI BOT may then inform the hiring manager, “Got it. We can always add to the responsibilities/what you will be doing section later.”

In a fourth example, the system may further ask questions about what skills or experience may be necessary or desired for the position. In an exemplary embodiment, the system may analyze the responsibilities of the position and may map skills to the listed responsibilities of the position, so that, if any responsibilities of the position appear to require skills that have not been described by the hiring manager, the system may prompt the hiring manager with further questions. (For example, according to an exemplary embodiment, “debugging the existing code base” may be listed as a responsibility, but no specific programming languages may be listed as necessary skills for the position. An AI BOT may be configured to ask the hiring manager about this and whether the necessary skills of the position should be expanded in order to reflect this responsibility.) Likewise, according to an exemplary embodiment, if any skills of the position appear not to be matched with particular responsibilities, the system may prompt the hiring manager with further questions. (For example, if the candidate is listed as needing to have “experience with deploying and managing applications using cloud software” but no responsibilities are listed that have to do with cloud-based applications, an AI BOT may be configured to ask the hiring manager about this and whether the responsibilities of the job should be expanded based on this required skill.)

In some exemplary embodiments, the system may analyze other positions in order to determine the likely skills or responsibilities associated with a particular job title, and may suggest these skills or responsibilities to the hiring manager. For example, according to an exemplary embodiment, an AI BOT may categorize an extensive set of jobs (which may, for example, be in the hundreds of millions) and extract the top listed skills and/or responsibilities for each job title or job type. For example, if the hiring manager is attempting to hire a candidate for a .NET developer role, the system may search for jobs having the title of .NET developer, and may further search for jobs having a job title that is a synonym of .NET developer. The system may then produce a list of the top required skills or responsibilities for this job title or job type; in some exemplary embodiments, the system may provide this list in a prioritized order, such that the hiring manager can make use of the list to more easily select which skills/responsibilities are necessary and which are merely desirable. In another exemplary embodiment, the other positions that may be analyzed may be, for example, the positions of employees at the company or past employees at the company.

An example conversation with a hiring manager with regard to the skills and experience of a potential candidate may be conducted as follows. An AI BOT may first ask, “Do you require a degree for this opening?” The hiring manager may then respond, “Ideally the candidate should have a Bachelors in Computer Science, but it's not a requirement.” The AI BOT may then classify this as being a desirable quality for candidates for the position, and may then ask, “Approximately how many overall years of experience in software development is needed? And what about specific to .NET?” The hiring manager may then respond, “Overall 7-8 years and .NET around 5 years.”

The AI BOT may then ask, “What are the essential skills/experience needed for this position? Let's stick with hard skills, we can talk about soft skills like communication skills, leadership traits right after. Please list out the skills in prioritized order.” The hiring manager may then respond, “.NET Development, C#, HTML5 and Java Script, T-SQL, experience with deploying to the cloud.” The AI BOT may then, in some exemplary embodiments, be configured to develop the skills that have been provided by the hiring manager in more detail, and may ask follow-up questions to this effect. For example, in an exemplary embodiment, an AI BOT may recognize that there are different versions of .NET framework (for example, an AI BOT may observe that version number information appears in association with the phrase “.NET framework” in other job postings that have been made by other companies) and for example may ask, “Does the candidate need experience with a specific .NET framework?” The hiring manager may then respond, “4.0 or 4.5.” The AI BOT may then respond, “Got it. Should the candidate have experience with certain Java Script Libraries like Angular or React? And do you want to define the # of years of experience required for Java Script?” The hiring manager may then respond, “That would be nice but not 100% necessary. The same around 5-8 years.” The AI BOT may then respond, “Ok, so I'll put experience with Java Script Libraries as a preferred skill. Is there any specific experience with T-SQL that you are looking for like optimizing queries?” The hiring manager may respond, “Yes, that's important.”

The AI BOT may ask further questions, such as about the production environment of the business, in order to further develop skills or experience that should be listed as necessary or desirable skills or experience for the job description. For example, an AI BOT may ask, “What cloud service are you using? AWS, Azure, Google Cloud, or something else?” A hiring manager may then reply, “Azure.” The AI BOT may then ask, “Do you want the candidate to have experience with any Azure solution sets? E.g. E-Commerce, DevOps, Blockchain, etc.?” A hiring manager may then reply “DevOps.”

The AI BOT may also attempt to develop “soft skills” that it may be necessary or desired for a candidate to have. In some exemplary embodiments, the AI BOT may be configured to develop “soft skills” in the same way as other skills, while in other exemplary embodiments a different approach may be taken; for example, according to an exemplary embodiment, an AI BOT may develop the part of a job description having to do with soft skills as being more goal-oriented, such that the job description describes tasks that the candidate must be able to accomplish rather than particular quantifiable skills that the candidate must possess. For example, a conversation may proceed as follows. The AI BOT may first ask, “Let's move on to soft skills. What are the types of personality traits you are looking for?” The hiring manager may respond, “We are a small organization so I need someone who can take full ownership of the project. We also have a team in India, so ideally someone who's worked with an offshore team who gets the culture and workstyle would be helpful.” The AI BOT may then respond, “OK, I'll add that to the job description. Furthermore, I will source candidates from companies that have an offshore development team.” The AI BOT may then ensure that candidates from companies having an offshore development team, or candidates who otherwise have a high likelihood of having worked with an offshore development team, may be given priority in sourcing.

According to an exemplary embodiment, an AI BOT may be configured to ask any other questions that may be pertain to necessary or desirable attributes of a candidate, such as may be desired. For example, in an exemplary embodiment, it may be desirable to consider “culture fit” in a hiring process, in addition to the formal requirements of the job. As such, in some exemplary embodiments, questions asked to the hiring manager may not be limited to the subject matter of the job itself, and may be used to develop details about the company culture and what attributes would make the candidate a good fit for the company culture, so that hiring for “culture fit” can be achieved. For example, if the company plays intramural sports with another company or the department plays intramural sports with another department, it may for example be desirable that a candidate has played on a company softball team or other such team, and this information may be asked about by the AI BOT or provided as an answer by the hiring manager.

Likewise, according to some exemplary embodiments, it may be desirable to include information in the job description that is related to the company (and which may advertise the company) in addition to information that is directedly related to the job itself. For example, in some exemplary embodiments, a job description may be further expanded to include information about the current state of the company or recent happenings in or involving the company, and an AI BOT may further be configured to ask the hiring manager about this information in order to provide it in the job description. For example, an AI BOT may be configured to inquire as to recent news about the company, may find that the company (in this case, a startup) has been the subject of a large infusion of venture capital, and may adapt this information into additions to the job description. For example, an AI BOT may ask “Is there anything else you would like me to know about your company?” The hiring manager may respond “Yes, we are about to receive a funding round from Greylock Partners.” The AI BOT may respond “Great!”

According to an exemplary embodiment, the questions asked to the hiring manager may be provided using any communications medium. For example, according to an exemplary embodiment, questions asked to the hiring manager may be provided using SLACK, email, SMS or MMS text messaging, SKYPE, or any other communications medium or combination of communications media, such as may be desired. According to an exemplary embodiment, questions asked to the hiring manager or conversations with the hiring manager may be persistent across each communications medium that is used to communicate with the hiring manager; for example, a first question may be asked using SLACK, answered via email, and a second question may be asked via email (or through some other communications medium) based on the first question and its answer.

In some exemplary embodiments, a job description preliminary input step 91 may be interchanged to at least some extent with a job description input step 92 in which one or more questions are asked to and answered by a hiring manager. For example, according to an exemplary embodiment, a hiring manager may first be asked several questions by an AI BOT as to the nature of the position for which hiring is to be conducted. Based on these initial questions, the AI BOT may select a template which may be used to start drafting the job description. The AI BOT may then next ask further questions to the hiring manager (such as, for example, where the job is intended to be provided) and may then further conduct searching and information retrieval based on the questions asked to the hiring manager (for example, company information or “About Us” information may be retrieved from the company website of a regional office closest to where the job is intended to be provided).

In some exemplary embodiments, the AI BOT may be configured to re-perform a preliminary input step 91 or elements of a preliminary input step 91 in response to one or more answers provided by a hiring manager in a job description input step 92. For example, an AI BOT may begin with a template which has been drafted based on the assumption that the position to be hired for is a US-based position. However, in a job description input step 92, it may be determined that the position to be hired for is, in fact, an overseas office that the company is planning to create. The AI BOT may exchange the template for the US-based position for a template for the overseas position, and may then make similar refinements to the overseas-based position template as had been made to the US-based position template.

In some exemplary embodiments, the AI BOT may be configured to generate new questions based on its search results, or otherwise based on the preliminary input information 91 and the job description information input by the hiring manager 91 through a question-and-answer process. For example, the AI BOT may be configured to identify contradictory information and generate new questions based on the contradictory information.

According to an exemplary embodiment, after the system has performed some aspects of either or both of a preliminary input step 91 and a job description input step 92, salary searching or any other searching or mining that may be necessary or appropriate 93 may be conducted in order to complete the draft job description. As before, in some exemplary embodiments, the steps of a preliminary input step 91, a job description input step 92, and a searching step 93 may be mixed to some extent; for example, a system may perform them simultaneously, may perform them in some other order or such that there are multiple instances of each step, or may perform these activities according to any other logic as may be desired.

For example, according to an exemplary embodiment, a searching step 93 may include a salary mining step. In such a step, the system may retrieve salary information or a salary range for the position from one or more comparable openings. This may constitute, for example, determining one or more jobs that are similar to the present job description using the job description data that has been provided thus far, and then determining the salaries or salary ranges offered for the similar jobs. According to some exemplary embodiments, the system may provide salary information by mining data from open jobs in the area (such as in a state or city or within a certain radius), salary data that has been collected from other candidates or from comparable employees in the company (including, for example, past salary history of those candidates if it has been offered, as well as past salary history or requested salaries of candidates undergoing an interview process), as well as from one or more jobs boards or other websites, such as, for example, SALARY.COM, GLASSDOOR.COM, or other APIs, such as may be desired. In some exemplary embodiments, salary information may be provided as a general figure or range for the area, or may be provided as a figure or range for certain companies, such as specific companies that have been identified as competitor companies; in some exemplary embodiments, a hiring manager may only be interested in outbidding their likely competitors for a candidate, and salary information may be provided for those companies only. Other selections of salary information (such as, for example, salary information for the companies in the candidates' employment history) may also be understood and may be provided, if desired.

For example, an exemplary embodiment of a system may conduct a conversation similar to the following. An AI BOT may first submit an average salary value or a range of salary values, such as, for example, “Based on similar openings in your area (Again, I am using a 30-mile radius from your office), the average salary is $98 k. Please keep in mind that I am using an aggregate value; this includes positions that are Jr. as well as Sr. and everything in between. Do you want salary information on Sr, Mid-Level, or Jr?” The hiring manager may respond with “Senior.” The AI BOT may then reply, “Ok, based on a senior role, the average salary is around $125 k. What range do you want to offer?” The hiring manager may then reply, “Let's keep it open from $115-$140 k depending on experience.”

Once a preliminary input step 91, a job description input step 92, and a searching and mining step 93 have been completed, the system may then generate a preliminary description for submission to a hiring manager 94. The hiring manager may then be provided with the opportunity to make any revisions to the description that may be necessary, or may provide one or more suggestions to the description, before providing approval. According to an exemplary embodiment, revisions to the description made or suggested by the hiring manager may be incorporated into the decision-making logic of the AI BOT by a machine learning program so that such revisions may be automatically made by the AI BOT in the future. In an exemplary embodiment, an AI BOT may be configured to provide guidance to the hiring manager for any additions or revisions to be made to the job description once a preliminary job description has been generated 94.

For example, an exemplary embodiment of a system may provide a preliminary description 94 to a hiring manager in the following manner. An AI BOT may first inform the hiring manager,

“Here's the job description I crafted for you based on the data you provided.” The hiring manager may then state, “Looks great, please add the following to the responsibilities section: (lorem ipsum).” The AI BOT may then add that information to the responsibilities section and may provide an updated job description.

The system may then perform sourcing for a list of candidates that match the job description. In some exemplary embodiments, this sourcing step may be, for example, a sourcing step as described in previous FIG. 1, such that the system may proceed to step 1 of FIG. 1 once a job description has been generated and approved. Alternatively, another method of sourcing may be used to generate a list of candidates 95, such as may be desired.

In a next step, a hiring manager may have the opportunity to review the candidates 96 and may provide approval of all, some, or none of the candidates. In some exemplary embodiments, the provision of at least some candidates (such as a first, local set of candidates) may be performed in real time or in substantial real time, such that the hiring manager may perform initial manual review of candidates almost immediately. The system may then source additional candidates while the hiring manager completes manual review, which can include sourcing via external job boards or databases in real time. Thus, the hiring manager may be presented with the best candidates from a variety of internal and external sources. In some exemplary embodiments, this may give the hiring manager the ability to see not only which local candidates are a match, but how extensive the candidate pool is likely to be for a position; if few local candidates are found that meet the requirements for a position, the hiring manager may be able to immediately update the job description to remove a required skill (or shift it from a necessary skill to a desirable skill), reduce a number of years required in a skill, reduce an educational or certification requirement, or otherwise reduce the requirements for the position. Likewise, if a large number of candidates are found that meet the requirements for the position, the hiring manager may be able to immediately update the job description to add a required skill (or shift skills from desired to necessary), or otherwise increase the requirements for the position, in order to obtain a more qualified candidate. Further, this may provide the hiring manager with real time access to the candidates in the market, and, based on the review of the results, the hiring manager can adjust the required skills to either increase or reduce the size of the candidate pool.

In some exemplary embodiments, the resumes of the candidates may be provided inside a message channel being used to communicate with the hiring manager; for example, in an exemplary embodiment, candidate resumes may be attached in an email, or provided in a SLACK message channel. The hiring manager may then be able to mark candidates as approved or not approved, or may be able to veto candidates; for example, the hiring manager may have a “thumbs up” or “thumbs down” for each candidate, or some other manner of selecting a candidate or otherwise marking a candidate as approved or vetoed, such as swiping left/right, or the like. In some exemplary embodiments, the system may solicit additional information from the hiring manager for each candidate that is not approved; for example, the hiring manager may be asked why the candidate was not acceptable. This may then be incorporated into the decision-making logic of the AI BOT or may be incorporated into the job description, if desired; for example, if the hiring manager has determined that the position has additional responsibilities or that candidates should have additional skills, these responsibilities or skills may be added to the job description, and candidates may be sourced who are able to meet the responsibilities or possess the skills needed to do so. Skills may also be shifted between required and desired skills, and vice-versa, in order to obtain a different candidate pool.

For example, an exemplary embodiment of an AI BOT may conduct the following conversation with a hiring manager. An AI BOT may first provide the hiring manager with the list of sourced candidates, and may say, “Here's the candidate profiles of the top 10 candidates that match the job description. Just click the thumbs up or down button or maybe for each candidate. If you ‘thumbs-up’ a candidate, I will reach out to the candidate to see if they are interested in your opportunity. If you click ‘thumbs down,’ please let me know why. The information you provide will help me provide better matches for you!” The hiring manager may then state, “Thumbs up 6 candidates and thumbs down on the other 4.” The hiring manager may then further provide information as to why the four candidates that received a “thumbs down” are inadequate; for example, they may specify that they are looking for a candidate who has more experience with developing SaaS Solutions, and who has more experience with JavaScript. The AI BOT may then take steps to update the job description accordingly, in a job description refinement step 97. Any “thumbs down” or other veto information may be used to update the data point matrices in real time.

For example, an exemplary embodiment of the AI BOT may make the following conversation. The AI BOT may say, “Ok, so would you like me to update the job description to include experience with SaaS? If so, would you like it as required or preferred skill?” The hiring manager may then reply, “Yes, please. Let's make it a required skill and let's see what you can find.” Based on the addition of SaaS as a required skill, the AI BOT may again perform searching, and may find additional candidates. On this basis, the AI BOT may say, “OK, here's another 4 candidates.” The hiring manager may then say, “Thumbs up for two [which may indicate that the hiring manager is interested in interviewing those two candidates, and may be treated as an interview request]. I have a question on Bill Smith. Does he have experience with working in a small team?” (Alternatively, the hiring manager may click “thumbs up” or “thumbs down” for those candidates.)

The AI BOT may say, “I will send your question to Bill Smith and get back with you on an answer. In the meantime, I have a total of 6 candidates that you are interested in interviewing [or otherwise manually contacting]. Andrew McDonald, Aaron Rodgers, Lebron James, Michael Jackson, Lisa Mann, and Janet Woodworth. Is that right?” The hiring manager may say “Yes.” The AI BOT may then work out the details of interviewing with each candidate, and may, for example, say “How much time do you want to allocate for each candidate?” The hiring manager may then specify a uniform time for each candidate, in this case “45 minutes,” or may specify a different time for one or more of the candidates if desired.

The AI BOT may then say, “Got it; tell me about your availability for an interview? Ideally, please provide a 2 to 3 hour window for 2 to 3 days?” The hiring manager may then say, “I have July 29 from 2-5 PM, August 3 from 1-4 PM, and August 4 from 5-7 PM EST.” The AI BOT may then say “Perfect. I'm going to reach out to each candidate. Typically, based on past results for similar positions, I usually can recruit approximately 30% of the candidates that you are interested in. There are a lot of factors that determine a candidate's interest level; compensation, location, company, and similar factors all play a part. If any of the candidates you shortlisted indicate that they are not interested in interviewing with your company, where possible, I will provide a reason why they are not interested in interviewing with your company.”

In some other exemplary embodiments of the above, it may be appreciated that the AI BOT may be provided with direct access to the hiring manager's calendar and suggest a few times that are open or available instead of the hiring manager directly providing these times. This can be done, for example, in real time using APIs available for Microsoft Exchange, Google Mail, and the like. (It can also be contemplated to have the AI BOT periodically receive exports from the calendar software, such as may be desired. It may also be contemplated to have the AI BOT run the “master” version of the calendar software, which may then be exported to other programs, such as may be desired.)

In some exemplary embodiments, it might be desirable for the hiring manager to then reach out directly to the candidates that are not interested in interviewing with the company, so that the hiring manager can determine the reason each candidate has for not interviewing with the company and can potentially amend the job description accordingly if desired or can potentially make a special arrangement with that candidate if desired. The system may facilitate this messaging by the hiring manager by providing a platform by which the hiring manager can reach out to candidates directly. For example, according to an exemplary embodiment, a system may provide an option for the hiring manager to send a message to the candidate asking them why they are not interested in interviewing. The candidate may in some circumstances provide a reason, such as “the commute will take too long,” that the hiring manager may be willing to discuss. For example, the hiring manager may say that they would be open to allowing the candidate to work from home 1-2 days per week. In another example, a candidate may say “the salary range is lower than what I am looking for,” and the hiring manager may indicate to the candidate that they would be willing to offer a higher compensation package to a particularly well-qualified candidate. Under such circumstances, according to an exemplary embodiment, the AI BOT may send a message to the candidate, for example using a recruiter persona, with a message such as “[CANDIDATE NAME], I just spoke to the hiring manager. He thinks that you would be a really good fit for the position, and is open to giving you the opportunity to working from home up to two days per week. With that said, would you be interested in interviewing?”

Alternatively, the candidate may in some circumstances provide a reason, such as “a non-compete agreement will not allow me to work for your company” or “I don't like certain things that the company has done,” that the hiring manager does not think warrant discussion or which the hiring manager does not think could be corrected by a special arrangement with the candidate. Under such circumstances, in some exemplary embodiments, this information may be associated with the candidate in a database and may prevent the candidate from being shortlisted for certain positions in the future.

Once the hiring manager has indicated their availability for an interview, the AI BOT may then reach out to the candidates for potential interviews. In some exemplary embodiments, the AI BOT may send the candidate messages bearing the name of the hiring manager, on the basis that the candidate may be more receptive to messages provided from hiring managers. In other exemplary embodiments, it may be desirable to use a recruiter persona. In some exemplary embodiments, it may be desired to use multiple personas, such as a recruiter and then a hiring manager; for example, according to an exemplary embodiment, an AI BOT may first reach out to a candidate using a recruiter persona, informing the candidate that the hiring manager is interested in the candidate, and if the candidate does not respond, the AI BOT may send another message to the candidate using a hiring manager persona, informing the candidate that the “hiring manager” wanted to contact them directly.

In some exemplary embodiments, this process may be performed as depicted in, for example, FIG. 5, with the AI BOT beginning at an initial contact step 41. In some exemplary embodiments, the process may be modified or may be expedited based on the hiring manager having already reviewed the resume of the candidate and having already indicated that they would want to move directly to an interview with the candidate. Alternatively, or in addition to the process depicted in FIG. 5, another process may be performed to reach out to the candidates for potential interviews; for example, in an exemplary embodiment, an initial message sent to the candidate may include a calendar of available interview times (or a link to such a calendar) which may update in real-time as other candidates select particular time slots, or which may update after all candidates have reported their availability. (For example, certain candidates may indicate that they are only able to make particular times and may be prioritized for those times, or candidates may indicate a certain number of available times in a ranked order of preference and may be assigned times based on their preferences.) In some exemplary embodiments, this process may be done in substantial real time, such that an interview may be arranged within a very short period of time, such as a half-hour.

The AI BOT may then contact the hiring manager again, after it has attempted to reach out to each of the candidates (or, in some exemplary embodiments, as each candidate accepts or declines the interview offer), and may say, “Great news, I was able to secure interviews with 3 of the candidates at the following time slots. On July 29 at 2 PM, you have an interview with Lebron James; on August 3 at 1 PM, you have an interview with Lisa Mann; and on July 3 at 3PM, you have an interview with Aaron Rogers.” (Alternatively, an AI BOT may inform the hiring manager in real time after each candidate indicates that they are available or unavailable for an interview, may provide a batch update reporting the responses of a certain number of candidates or after a certain period of time, may automatically update a calendar of the hiring manager to show interviews that have been accepted by particular candidates at particular times, or may perform more than one of the above or a different reporting process.) The AI BOT may then specify why the candidates that did not elect to interview for the position did not do so. For example, “Janet Woodworth just landed a new job at GOOGLE and is no longer in the market. Michael Jackson is looking for a higher compensation package and has specified that he wants upwards of $160 k. Bill Smith has yet to reply.” Finally, the AI BOT may ask for further instructions; “Do you want me to find additional candidates or would you like to complete the interview of the 3 candidates first?” The hiring manager may then be able to specify whether more candidates should be retrieved, and, if so, when; for example, the hiring manager may say “Let's wait until I interview these candidates. I am hoping we can make a hire on one of them.”

In an exemplary embodiment, the AI BOT may then be configured to keep track of each of the candidates for whom an interview has been scheduled. In some exemplary embodiments, it may be necessary for a candidate to reschedule or cancel an interview (for example, if they have a need to deal with a family emergency) or it may be necessary for a hiring manager to reschedule or cancel an interview. In the event that an interview needs to be rescheduled or canceled, the AI BOT may keep the hiring manager updated. In an exemplary embodiment, an AI BOT may be linked to a calendar of the hiring manager and may be configured to automatically call attention to a scheduling conflict if it arises; for example, if the hiring manager is sent a notice of a mandatory departmental meeting to take place during a time an interview is scheduled to happen, the AI BOT may automatically generate a message indicating that the interview may need to be rescheduled or canceled. In an exemplary embodiment, an AI BOT may further be configured to reschedule or cancel an interview in an interview period or schedule a follow-up interview, if, for example, the hiring manager indicates that additional time may be necessary to complete the interview process with the candidate.

Turning now to exemplary FIG. 10, FIG. 10 may show a more detailed breakdown of a job description preliminary input step 91. According to an exemplary embodiment, a job description preliminary input step 91 may first begin by determining, in a determination step 912, whether an existing description exists or not 911. If an existing job description for a position exists, and it is desired to modify this job description rather than starting from a blank slate to create a new job description, the existing job description may be loaded 913. However, if no existing job description exists, the system may start from a blank slate or highly-generic job description, or may start with the template that is most closely related to the subject matter of the job 914.

In a next step, regardless of whether a blank slate or template 914 is loaded or whether an existing job description 913 can be loaded, the system may load in any other information that may be available. For example, according to some exemplary embodiments, the system may load a company's informational pages 915, which may include, for example, the “about us” page of a company, the social media pages of a company, or any other information such as may be desired. The system may also load in information provided by the hiring manager 916, such as information provided in the form of notes or disconnected bullet points. (For example, in some exemplary embodiments, a hiring manager may instruct an AI BOT to create “a new software engineering position for managing our new cloud application,” and the AI BOT may incorporate this information into the job description before any questions are asked to the hiring manager.)

Once the system has accessed the information available to it in a preliminary input step 91, the system may formulate one or more questions to be asked to the hiring manager 917 in a next step 92. These questions may be formulated based on, for example, one or more gaps that exist in the information that has been provided thus far, or based on any other criteria such as may be desired.

In some exemplary embodiments, a system may store historical data on any or all data collected herein in order to determine trends. For example, in some exemplary embodiments, it may be desired to collect trend data on job titles, job posting frequency, candidate response time or response rate, or any other such information as may be desired. Data may be collected from, for example, data mining, or may be directly provided by one or more companies or collected from any other source, such as may be desired. In some exemplary embodiments, trend data may include data on how long it may take to fill positions or for competitors or other companies to fill positions; this may be determined or guessed from, for example, an amount of time a job posting of a competitor stays up. In some exemplary embodiments, this may be used to further refine the system; for example, if job postings with descriptions having particular language or keywords, or other attributes, are being taken down much more quickly than comparable job postings, this description language may be determined to be more effective. In some exemplary embodiments, a system may also be used to determine which job postings are duplicates and may prune duplicate job postings if this is desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

For example, in some exemplary embodiments, it may be desired to structure the above invention as a Software as a Service (SaaS) platform, which may be accessible through a public API. According to such an exemplary embodiment, one or more clients, who may for example be hiring managers at outside companies, may make use of the public API to send jobs to the SaaS platform. The SaaS platform will then operate to generate a curated list of candidates for submission back to the client, which may be, for example, delivered directly into the application tracking system of the client. In some exemplary embodiments, some or all (or none) of the above processes may be made accessible by a public API, as may be desired.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for automated dialectic generation of a job description, comprising:
providing an automated job description system, the automated job description system comprising a natural language processing engine, a processor, a memory, and a network connection;
generating at least one question to be provided to a user, providing the at least one question to the user, receiving at least one answer from the user, and parsing the at least one answer into one or more specified job requirements;
data mining, via the network connection, employment data for one or more extrinsic job requirements;
generating a preliminary job description based on the one or more specified job requirements and the one or more extrinsic job requirements; and
providing the preliminary job description to the user.

2. The computer-implemented method of claim 1, wherein the method further comprises:
identifying a job subject area; and
automatically loading, with the processor, a job description template for the job subject area, the step of automatically loading the job description template comprising at least one of the set of: retrieving the job description template from a memory, and automatically retrieving the job description template via the network connection;
wherein the step of generating a preliminary job description comprises modifying the job description template based on the one or more specified job requirements and the one or more extrinsic job requirements.

3. The computer-implemented method of claim 1, wherein the method further comprises:
identifying an existing job description for a position, the existing job description comprising at least one of the set of: an unposted job description, and a previously-posted job description provided in the memory or via the network connection;
automatically loading, with the processor, the existing job description;
wherein the step of generating a preliminary job description comprises modifying the job description template based on the one or more specified job requirements and the one or more extrinsic job requirements.

4. The computer-implemented method of claim 1, wherein the method further comprises:
generating a plurality of questions to be provided to the user through an iterative process, wherein a first answer of the user to a first question in the plurality of questions is used to generate a second question in the plurality of questions.

5. The computer-implemented method of claim 1, wherein the data mining step comprises:
identifying, based on the at least one answer of the user, a plurality of related job descriptions in at least one job database; and
identifying, from the plurality of related job descriptions, the one or more extrinsic job requirements.

6. The computer-implemented method of claim 1, wherein the method further comprises:
receiving a revised job description from the user; and
automatically posting the revised job description in at least one job database.

7. The computer-implemented method of claim 6, wherein the method further comprises:
based on the revised job description received from the user, performing at least one of:
generating at least one further question to be provided to a user, providing the at least one further question to the user, receiving at least one further answer from the user, and parsing the at least one answer into one or more revised job requirements; and
data mining, via the network connection, employment data for one or more revised job requirements, and generating at least one comparison based on the mined employment data.

8. The computer-implemented method of claim 1, wherein the method further comprises:
selecting a first communications method for providing the at least one question to the user;
receiving the at least one answer from the user via a second communications method; and
updating a communications preference to be the second communications method.

9. The computer-implemented method of claim 1, wherein the data mining step is specifically a salary mining step, and wherein the salary mining step includes:
identifying one or more comparable openings, wherein a comparable opening is an opening with a plurality of similar attributes selected from the set of: a location, a title, a responsibility of a worker in a hiring company, and a posted responsibility of a job description posted in a job database; and
determining a salary or salary range from each of the one or more comparable openings.

10. The computer-implemented method of claim 1, further comprising sourcing a plurality of candidates based on the one or more specified job requirements and the one or more extrinsic job requirements of the preliminary job description.

11. The computer-implemented method of claim 10, wherein the plurality of candidates are sourced in substantial real time and displayed to the user as they are sourced.

12. The computer-implemented method of claim 11, further comprising:
receiving, from the user, at least one job description adjustment request comprising an adjusted job description, and adjusting the sourcing to use the adjusted job description; and
generating a new plurality of candidates in substantial real time and displaying the new plurality of candidates as they are sourced.

13. The computer-implemented method of claim 10, further comprising:
receiving at least one of an approval message or a disapproval message for at least one of the plurality of candidates.

14. The computer-implemented method of claim 13, further comprising:
receiving a disapproval message for a candidate in the plurality of candidates, and, based on the disapproval message, generating at least one question to be provided to the user regarding the suitability of the candidate.

15. The computer-implemented method of claim 14, further comprising:
receiving a disapproval answer from the user, and, based on the disapproval answer, updating a job description.

16. The computer-implemented method of claim 13, further comprising:
receiving an approval message for a candidate in the plurality of candidates;
identifying, from a calendar of a user, a potential interview time, and identifying, from a set of preferences of a user, a potential interview method; and
automatically preparing and sending an interview request for the potential interview time and the potential interview method.

17. The computer-implemented method of claim 16, further comprising:
receiving, from the candidate, an interview decline message; and
automatically generating a recommendation for the user based on the interview decline message.

18. The computer-implemented method of claim 16, further comprising:
receiving, from the candidate, an interview decline message; and
preparing and sending a communication with a revised job description based on the interview decline message.

19. An automated job description system for automated dialectic generation of a job description, comprising a natural language processing engine, a processor, a memory, and a network connection, the automated job description system configured to perform the steps of:
generating at least one question to be provided to a user, providing the at least one question to the user, receiving at least one answer from the user, and parsing the at least one answer into one or more specified job requirements;
data mining, via the network connection, employment data for one or more extrinsic job requirements;
generating a preliminary job description based on the one or more specified job requirements and the one or more extrinsic job requirements; and
providing the preliminary job description to the user.

20. A non-transitory computer-readable medium on which is stored program code that, when executed, causes a computer system comprising a natural language processing engine, a processor, a memory, and a network connection to perform the steps of:
generating at least one question to be provided to a user, providing the at least one question to the user, receiving at least one answer from the user, and parsing the at least one answer into one or more specified job requirements;
data mining, via the network connection, employment data for one or more extrinsic job requirements;
generating a preliminary job description based on the one or more specified job requirements and the one or more extrinsic job requirements; and
providing the preliminary job description to the user.
